(19) United States
(12) Patent Application Publication
(10) Pub. No.: US 2001/0032170 A1
(43) Pub. Date: Oct. 18, 2001

(54) Method and system for an on-line private marketplace

(76) Inventor: Beerud D. Sheth, Sunnyvale, CA (US)

Correspondence Address: FENWICK & WEST LLP, TWO PALO ALTO SQUARE, PALO ALTO, CA, 94306, US

(21) Appl. No.: 09/775,717

(22) Filed: Feb. 1, 2001

Related U.S. Application Data
(63) Continuation-in-part of application No. 09/648,408, filed on Aug. 24, 2000.
(60) Provisional application No. 60/150,611, filed on Aug. 24, 1999.

(51) Int. Cl. G06F 17/60

(52) U.S. Cl. 705/37; 705/26; 705/7

(57) ABSTRACT

A computer implemented method for procuring services includes establishing a private marketplace with access restricted to a predetermined set of buyers and a predetermined set of vendors. The private marketplace owner uses the private marketplace to procure services by inviting bids on a project from a subset of the vendors, receiving at least one bid on the project from at least one of the subset of vendors, and accepting one of the bids. The users of the private marketplace work with the vendor on the project in a collaborative workspace. The private marketplace owner monitors the marketplace through the use of a series of customized reports.

### CROSS-REFERENCE TO RELATED APPLICATIONS

This application is a continuation in part of U.S. Application Ser. No. 09/648,408 entitled “Method and Apparatus for an Electronic Marketplace for Services Having a Collaborative Workspace” of Sheth and Anumolu, filed Aug. 24, 2000, the entirety of which is herein incorporated by reference.

This application claims priority, under 35 U.S.C. §119(e), from U.S. Provisional Patent Application Ser. No. 60/150,611, “Method and Apparatus for an Electronic Marketplace for Services Having a Collaborative Workspace,” by Sheth and Anumolu, filed Aug. 24, 1999, the entirety of which is herein incorporated by reference.

This application is related to U.S. patent application Ser. No. 09/644,665, “Method and System for Cobranding a Web Site,” by Sheth and Anumolu, filed Aug. 24, 2000, the entirely of which is herein incorporated by reference.

### BACKGROUND

A. Technical Field

The present invention relates generally to the World Wide Web, and more particularly, to a system and method for managing service providers and outsourcing projects online.

B. Background of the Invention

The nature of business is changing. The management, procurement and delivery of services are becoming decentralized as businesses increasingly outsource for their needs. New kinds of business organizations are emerging as employees seek greater flexibility through working independently. Large, vertically integrated companies are being replaced by fluid, self-managed groups of diverse individuals who form online teams, engage in a common task and disband after the project's completion. In this new economy, there is a strong need for infrastructure that can facilitate sourcing, buying and selling services more efficiently.

The traditional process of outsourcing projects and procuring services is highly fragmented. In the offline world, a buyer of services has traditionally located service providers through the local telephone directory, print publications or personal referrals. Once a service provider was located, however, the buyer had to contact him or her, arrange a method or time to review his or her prior work or otherwise evaluate his or her qualifications for the project and negotiate a price. Even in the age of the Internet, thousands of service providers, both individuals and companies, offer their services, but their individual web sites or online postings are often difficult to find or do not disclose sufficient information regarding the quality of their work product, reputation or availability. In addition, a buyer of services still has to contact each vendor individually through email or some other means, evaluate their qualifications and negotiate specifications, availability and price on an individual basis.

The process of managing outsourced projects and collaborating with service providers has also been highly inefficient. As a result, comparison-shopping, negotiation and collaboration with services providers have traditionally been time-consuming, inefficient and costly for tie buyer of services.

For larger entities, such as corporations, the aggregation of the individual service needs of individuals and departments within the corporation increases the need for an efficient services procurement process. A large corporation may outsource hundreds of projects annually, each with a substantial purchase price. The administrative overhead alone for procuring and managing the services may be a considerable financial burden.

The fragmentation of the traditional market for services both online and offline has created a strong need for infrastructure that can facilitate access to service providers and their services in an efficient manner, as well as manage the process of outsourcing for corporations. Various entities have implemented online procurement solutions in recent times for products that automate the comparison, selection, purchasing and billing and payment processes, but there is no similar solution for services.

What is needed is a way to continue the concept of aggregation of individual buyers within a corporation and vendors, which is currently provided by online marketplaces, so that the services offered by various providers can be aggregated on a higher level. What is further needed is a forum for outsourcing large numbers of high value projects to skilled vendors.

### SUMMARY OF THE INVENTION

The present invention offers a method and system that allows corporations to aggregate their services procurement through a central automated, online process. A described embodiment of the present invention is described in the context of an online private marketplace used by corporations to procure services. It is clear that the invention has wider implications and could also be successfully implemented to apply to other types of workflow processes, such as job boards and hiring and staffing networks; and customized for specific vertical industries.

Such a private marketplace allows businesses to conduct all services outsourcing and manage relationships with service providers through one venue, which standardizes and increases the efficiency of the services procurement process. The businesses may also reduce their project management requirements by utilizing third party project management support. Because the private marketplace is related to a larger services marketplace, where any individual within the corporation has the option at any time to access service providers on the public marketplace, the businesses may take advantage of an increased pool of resources and a large network for obtaining reliability information for various service providers.

In a private marketplace, a business or owner of the marketplace may establish an exclusive group of users and vendors. Access to the private marketplace is restricted to these users, and preferred vendors are invited to bid on projects on a case-by-case basis. The marketplace owner manages the vendors by creating and editing lists of vendors that may be organized by type of service provided by the vendor, feedback rating of the vendor, etc. The owner may, thus, easily submit a project to those vendors who would be qualified or most interested in bidding on the project.

The private marketplace users describe projects, preview the posting of the project, invite specific vendors to bid on the project, and may send a personal message to each invited vendor. The vendors may review the projects for which they have been invited to submit a bid and then place a bid for one or more projects. Based on the bids and various other factors, the user chooses a vendor to complete the given project. The user and the vendor may then collaborate in a private workspace until completion of the project.

Once a project has been all or partially completed, the vendor may submit an invoice for the services to a central server. The central server consolidates all invoices received for each business and sends the business one consolidated bill. Once funds are received from the business, these finds are dispersed to the individual vendors.

### BRIEF DESCRIPTION OF THE DRAWINGS

FIG. 1 is a diagram of a preferred embodiment of a system including a private marketplace.

FIG. 2 is a flow diagram of a preferred embodiment of the overall process for using a private marketplace.

FIG. 3 is a flow diagram of a preferred embodiment of the setup process.

FIG. 4 is a preferred embodiment of a user interface for the private marketplace user registration.

FIG. 5 is a preferred embodiment of the user interface for the login procedure.

FIG. 6 is a preferred embodiment of a user interface for entering contact information of a vendor.

FIG. 7 is a preferred embodiment of the user interface for creating a new list of vendors.

FIG. 8 is a preferred embodiment of a user interface for accessing a contact list of vendors.

FIG. 9 is a flow diagram of a preferred embodiment for procuring services.

FIG. 10 is a preferred embodiment of the user interface for posting an RFP (request for proposal).

FIG. 11 is a preferred embodiment of the user interface for requesting quotes from specific vendors.

FIG. 12 is a preferred embodiment of the user interface for posted projects received by the vendors.

FIG. 13 is a preferred embodiment of the user interface for adding a personal message to a posted project.

FIG. 14 is a preferred embodiment of a user interface for entering a bid on a posted project.

FIG. 15 is a preferred embodiment of a user interface displaying the current bids for a given project.

FIG. 16 is a flow diagram of a preferred embodiment of the payment process.

FIG. 17 is a preferred embodiment of the dashboard user interface.

FIG. 18 is a diagram of a system including a described embodiment of the present invention.

FIG. 19 is a diagram of an example of a server site.

FIG. 20 is a block diagram of a data structure for a collaborative workspace.

FIG. 21 is a diagram of one embodiment of a file structure used to implement workspaces.

FIG. 22a user interface for posting a RFP.

FIG. 22b is a user interface for posting a fixed-price service offer.

FIG. 22c is a user interface for placing a bid on a project.

FIG. 23a is a user interface for per project workspaces.

FIG. 23b is a user interface for a shared folder.

FIG. 23c is a user interface for a private message board.

FIG. 24 is a user interface showing a list of current requests for proposals (RFPs) available on the website.

FIG. 25 is a user interface showing a list of current fixed-price services available on the website.

FIG. 26 is a user-specific page on the website.

FIG. 27 is a flow diagram of the RFP process.

FIG. 28 is a flow diagram of the commodity process.

FIG. 29 is a flow diagram of a work process within the sandbox.

FIG. 30 is a flow diagram of the optimizer related process used for commodity services.

FIG. 31 is a flow diagram of the optimization process.

FIGS. 32(a) and 32(b) are diagrams showing that the cobranding concept allows aggregation of buyer and seller postings from cobranded web pages having appearances specified by the cobranding partners.

FIG. 32(c) is a diagram of a system including a central server and users who access the central server from different cobranded pages.

FIG. 32(d) is a diagram of a system including a central server and users who access the server from different cobranded pages, where the central server filters the information before sending it to the cobranded web pages.

FIGS. 33(a) and 33(b) show examples of content served from a central web server to cobranding web pages in the described embodiments of the present invention.

FIGS. 34(a)-34(d) are flow charts showing examples of methods performed by the central server in response to requests for content received via cobranding partners.

FIG. 35 is a diagram of an embodiment of the central web server.

FIGS. 36 and 37 are examples of a web page that allows a partner to build a link that will be placed on the partner's web page and that will point to the cobranded page.

FIG. 38 is an example of web page that provides a link for a partner to place on his web page to allow users to access the cobranded page.

FIG. 39 is example of a partner web page having a link to a cobranded page.

FIGS. 40(a) and 40(b) are examples of a web page that allows a partner to specify the appearance of his cobranded web page.

FIG. 40(c) is an example of a preview of a cobranded web page.

FIGS. 41(a) and 41(b) are examples of cobranded web pages having the same logo but different startpages.

FIG. 41(c) is an example of a web page where the startpage is displayed in a frame, so the logo is always visible.

FIGS. 42(a) and 42(b) are flow chart showing a method of allowing a partner to set up a cobranded web page.

FIG. 43 is an example of an affiliate page.

FIGS. 44(a) through 44(d) show examples of cobranded web pages.

### DETAILED DESCRIPTION OF EMBODIMENTS

### Private Marketplace

The private marketplace allows enterprises to procure services in a customized manner. The owner of the marketplace has control over access to the marketplace by buyers and vendors of services. Use of the private marketplace enables the owner to control the quality of the procured services by inviting specific vendors to bid on projects. Because the private marketplace is tailored to the needs of the marketplace owner through customized services, vendor lists and reporting, the efficiency of the service procurement process is maximized. In a preferred embodiment, the private marketplace is sold as software to a marketplace owner, who works with the central server to customize the marketplace. As a result, the marketplace owner may restrict access to the marketplace, such that only registered users and vendors may access the marketplace.

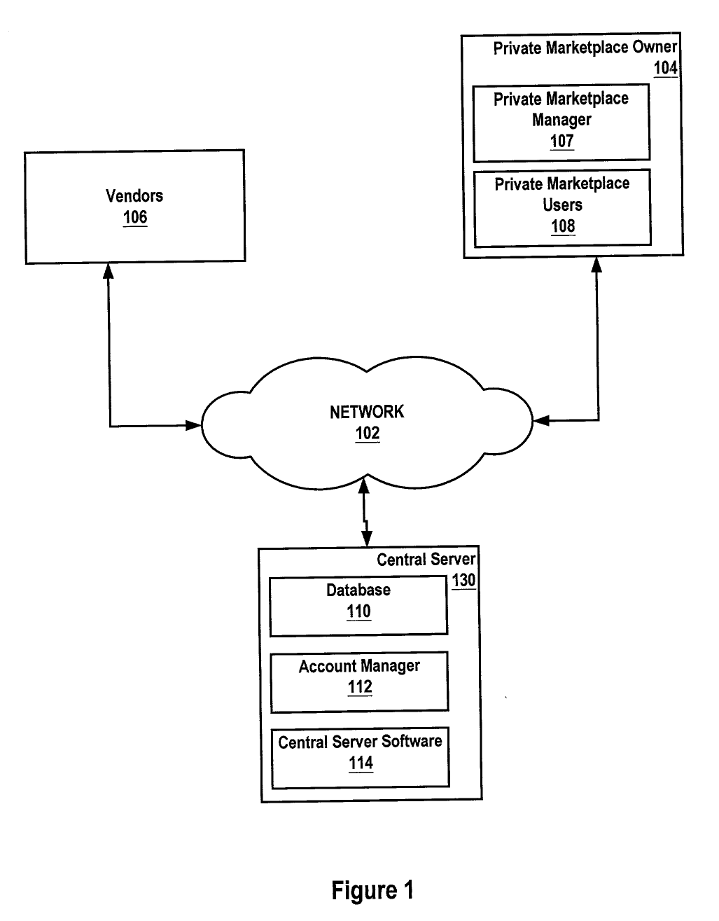

FIG. 1 is a diagram of a preferred embodiment of a system including a private marketplace. The system includes a network 102, a private marketplace owner 104, a central server 130, and a group of vendors 106. The private marketplace owner 104 includes a private marketplace manager 107 and a group of private marketplace users 108. The central server 130 includes a database 110, an account manager 112, and central server software 114. The private marketplace owner 104, the central server 130, and the group of vendors 106 are all connected via the network 102.

In a preferred embodiment, the network may be the Internet, a proprietary network or an intranet, however other networks may also be used. Alternately, in some embodiments, one or more of the vendors, central server, manager and users may communicate indirectly or directly without passing through the network 102. It will be understood that FIG. 1 shows only an example of one possible architecture.

The private marketplace owner 104 may be an individual, business, or other entity, such as a school that has a need for procuring services. The central server 130 receives, processes, stores and distributes information between the vendors 106 and the private marketplace owner 104. In a preferred embodiment, the information may include detailed identifying and contact information for the vendors 106 and private marketplace users 108, descriptive information regarding RFPs (requests for proposals) and bids on RFPs, statistical reporting information, payment information, etc. The vendors 106 are service providers who place bids to perform all or a portion of one or more requested services.

The private marketplace manager 107 is the portion of the private marketplace owner 104 that is responsible for customizing the look and feel of the private marketplace, determining which users and vendors will have access to the private marketplace, managing the business reports, and determining the types of services to be procured. The private marketplace users 108 may be employees or members of the private marketplace owner 104 or other software programs performing a procurement function. The private marketplace users 108 together with the vendors 106 are allowed exclusive access to the private market. The private marketplace users 108 post the RFPs to procure services needed by the private marketplace owner 104.

The database 110 stores information about the private marketplace, including by way of example, information about the private marketplace users 108, the vendors 106, and individual RFPs and bids. This database 110 may be a filtered subset of a larger database stored on the central server 130. Alternatively, the database 110 may be stored separately as a unique database either on the central server 130 or within the private marketplace owner 104.

The account manager 112 is the portion of the central server 130 that manages the individual private marketplaces. As an example, the account manager 112 may be implemented as part of the central server software 114 or the instructions for the account manager may be stored in a separate memory and/or implemented by a separate processor. The processing for the private marketplace by the central server software 114 or by the private marketplace owner 104 may be implemented as software instructions. The software for the account manager 112, the central server software, and the software within the private marketplace owner 104 is stored in a memory and executed by a computer processor, although the invention is not limited to this embodiment. These instructions may be stored on a computer-readable medium, such as a floppy disk, CD ROM, or any other appropriate storage medium.

The account manager 112 on the central server 130 establishes the information necessary to run the private marketplace. For each private marketplace, the account manager 112 establishes the private marketplace user accounts, creates categories for the marketplace, and creates a default contact list of vendors. The categories for the private marketplace are variable and depend upon the business needs of the private marketplace owner 104. These categories may include establishing networking capabilities or determining the Internet bandwidth requirements for the private marketplace. The setup of the private marketplace user accounts and the contact list of vendors is discussed in greater detail below.

The vendors 106 and the private marketplace users 108 preferably access the central server 130 via browsers connected to a network such as the Internet, although other networks including proprietary networks and intranets may also be used. In a preferred embodiment, the users' browsers may operate in conjunction with one or more computer systems such as desktop computer, laptop computers, network computers, handheld storage devices, PDAs, cellular telephones, etc. A preferred embodiment of the present invention is implemented in a client server environment as described herein. The Internet is one example of such a client server environment, however, any other appropriate type of client server environment, such as an intranet, a wireless network, a telephone network, etc., may also be used. The present invention is not limited to the client server model and could be implemented using any other appropriate model, for instance, an application hosting model. The described embodiment uses the worldwide web, although other protocols may also be used and other newer versions of the web may be used as well. A redirector may also be employed between the browsers and the central server 130.

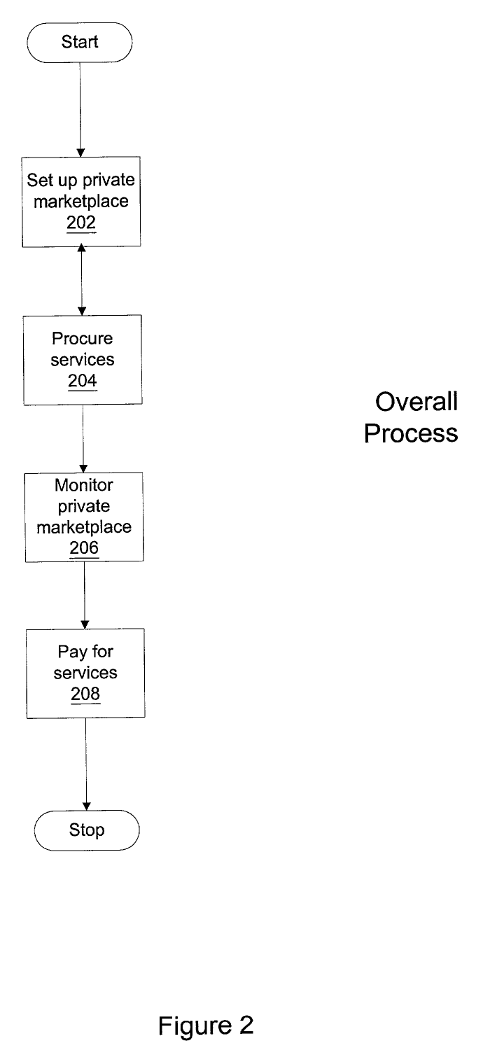

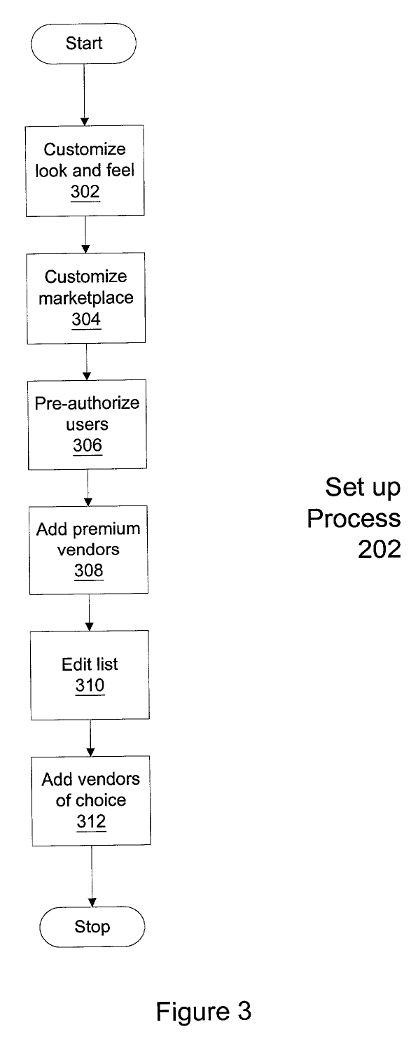

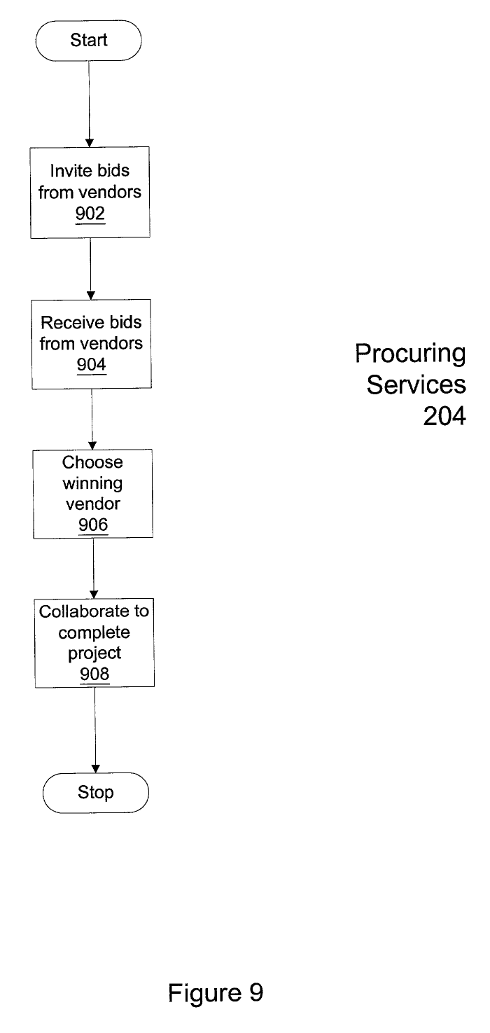

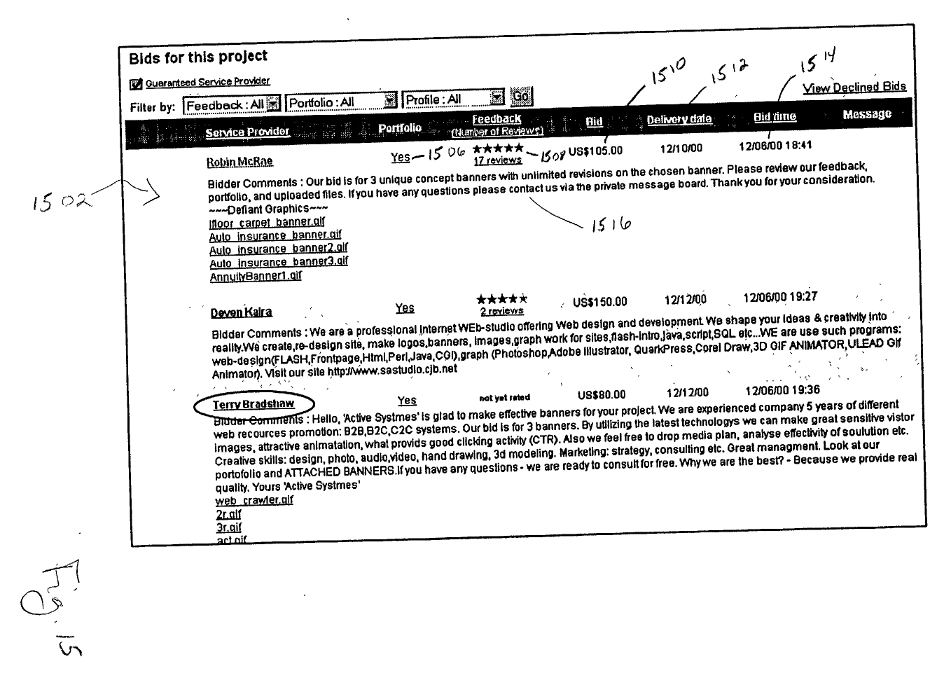

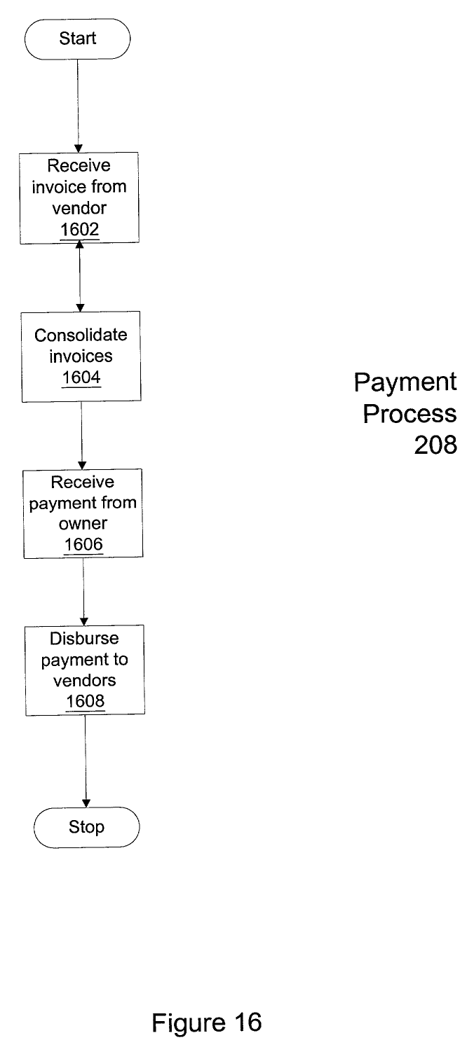

FIG. 2 is a flow diagram of a preferred embodiment of the overall process for using a private marketplace. In step 202, the central server 130 and the private marketplace owner 104 collaborate to set up a private marketplace. The setup process for the private marketplace is discussed in greater detail with reference to FIG. 3 below. In step 204, the private marketplace users 108 procure services. The process for procuring services is discussed in greater detail in the description of FIG. 9 below. Based on the business needs of the private marketplace owner 104, the central server 130 monitors 206 the private marketplace. Once the vendors 106 have completed various projects and returned the deliverables to the private marketplace users 108, the private marketplace owner 104 pays 208 for the services rendered. The invoicing, account tracking and payment process 208 is discussed in greater detail in the description of FIG. 16 below.

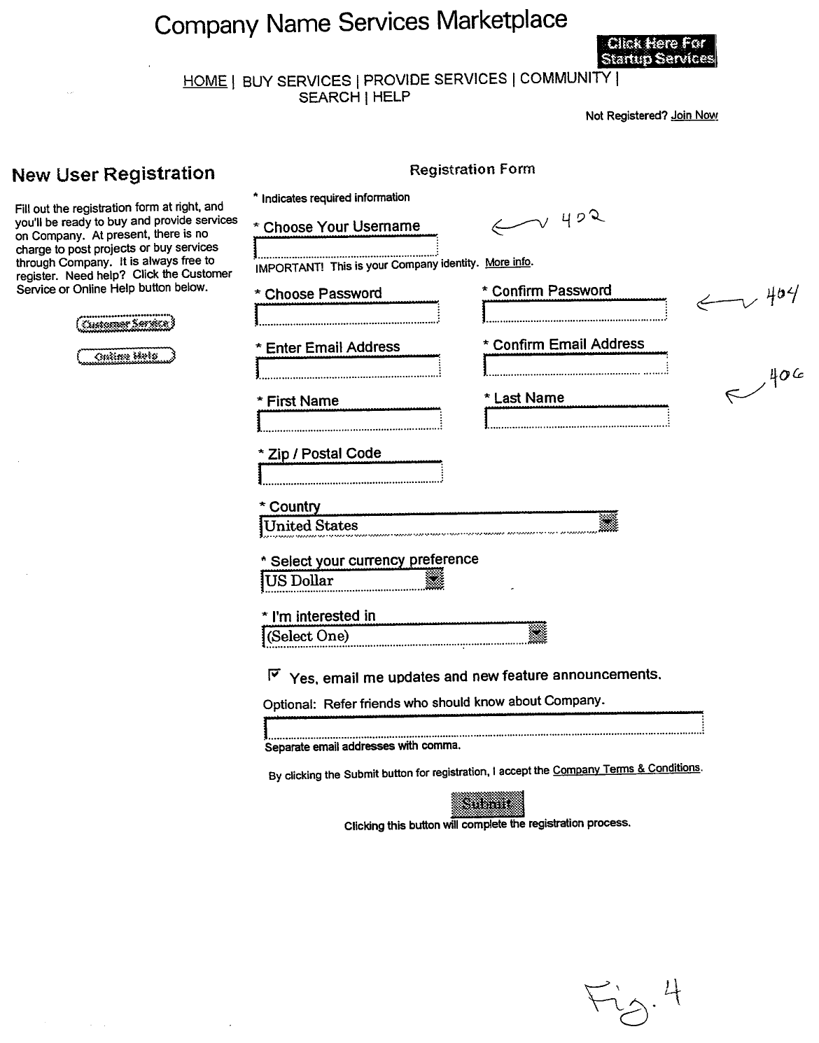

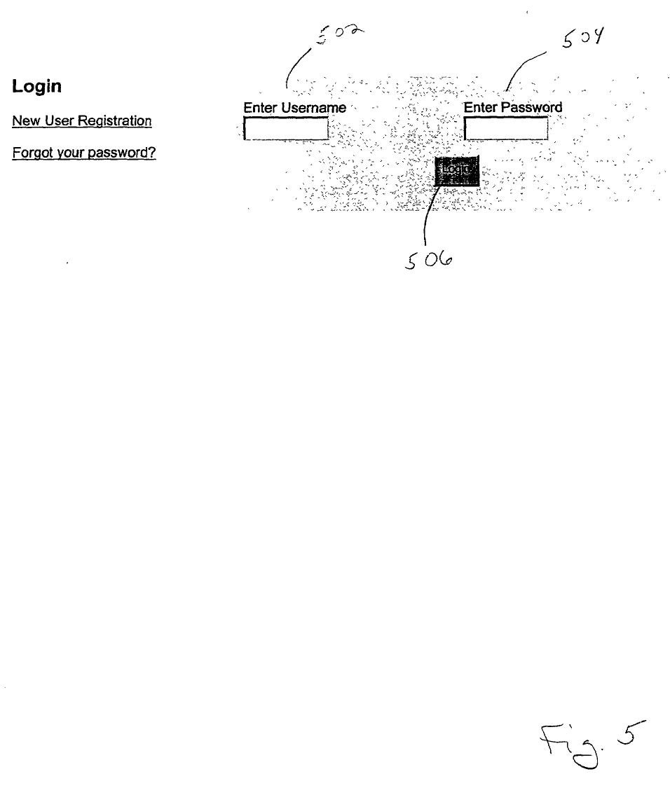

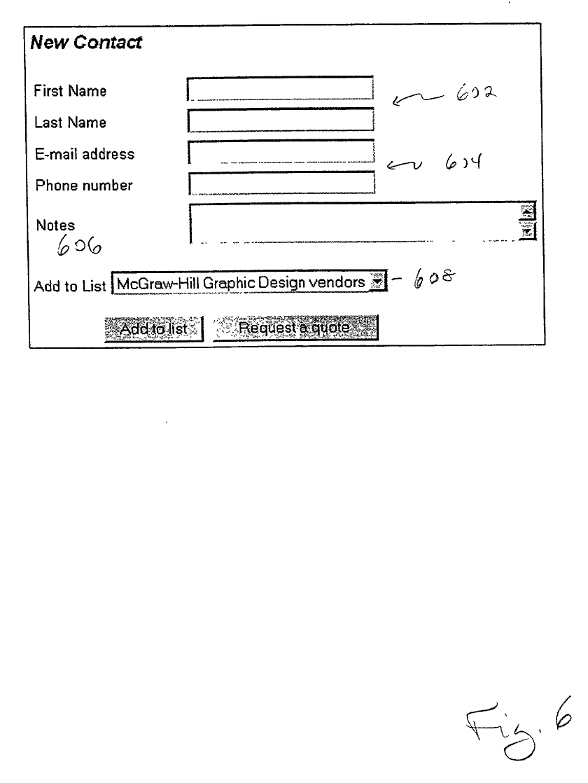

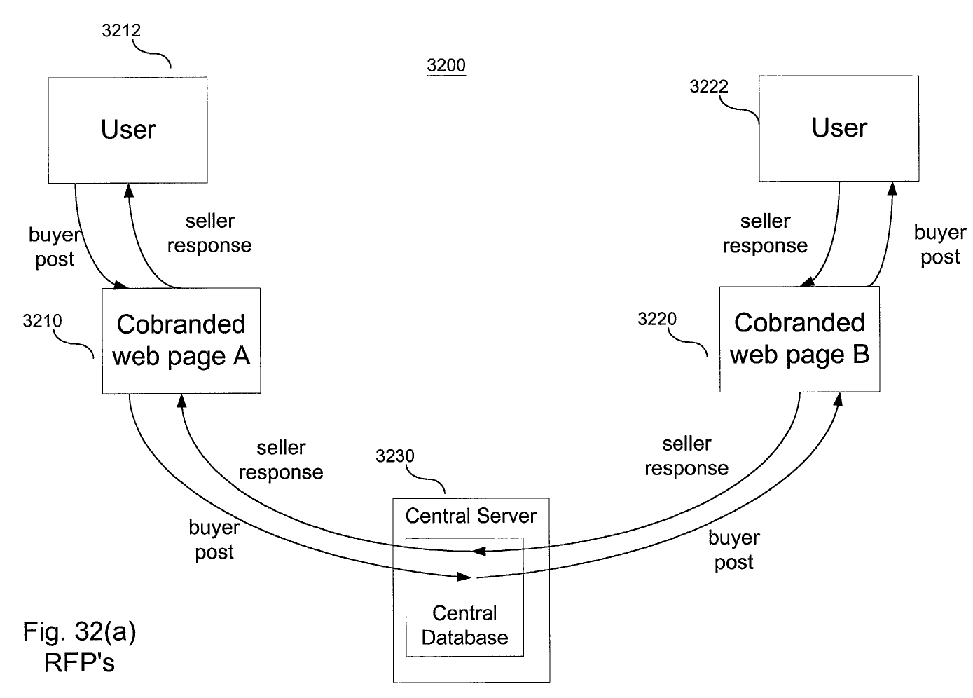

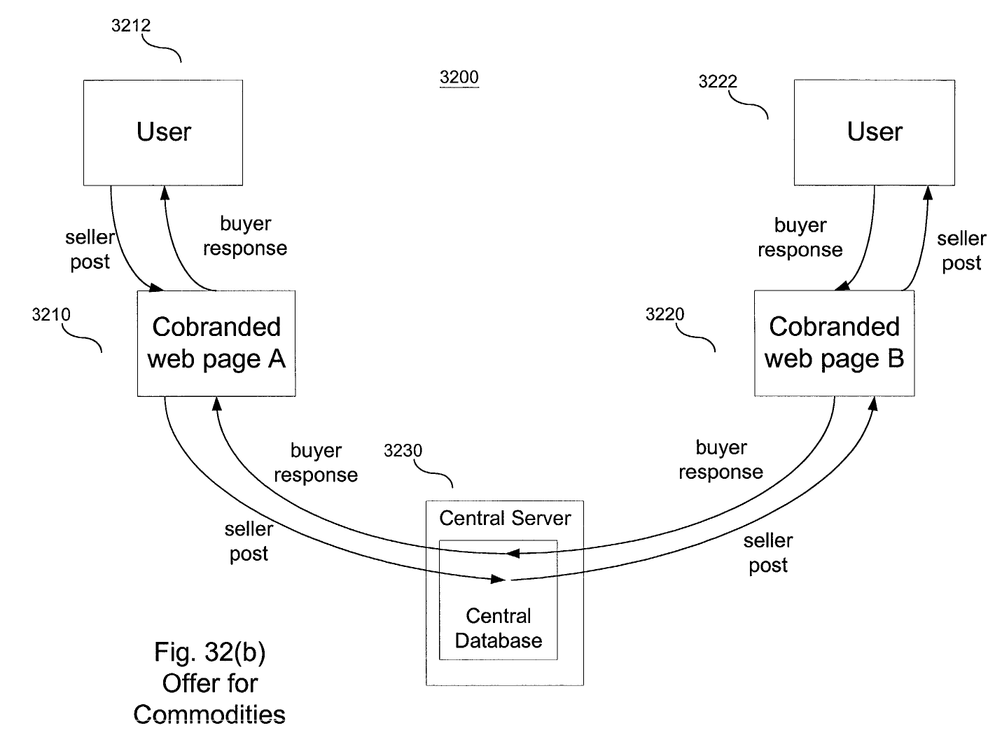

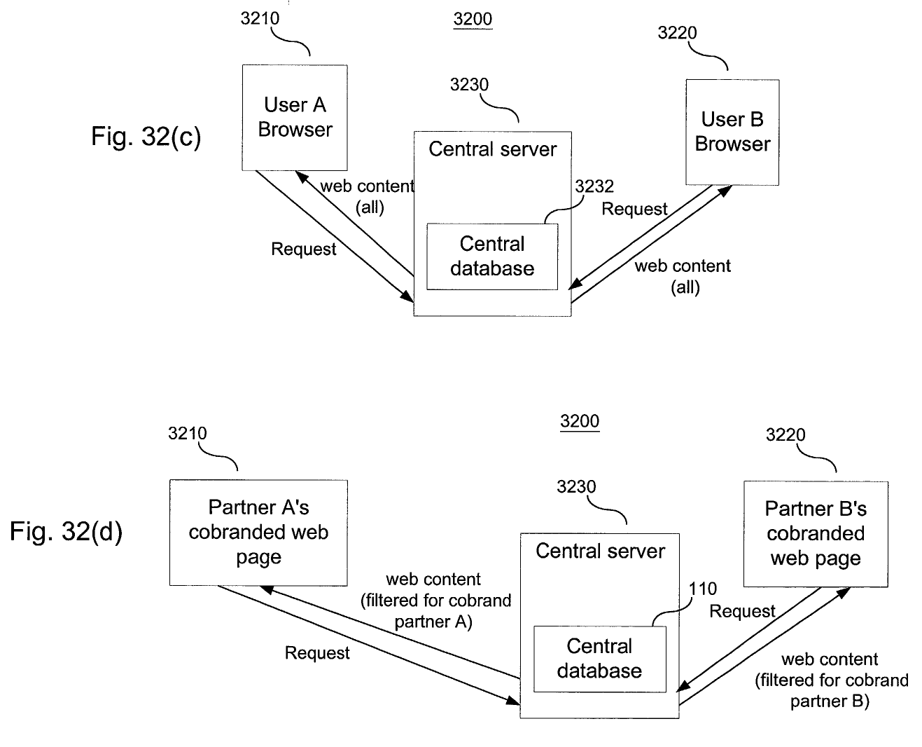

FIG. 3 is a flow diagram of a preferred embodiment of the setup process 202. The private marketplace manager 107 and the account manager 112 on the central server 130 collaborate in step 302 to establish a customized look and feel for the private marketplace. The customized look and feel of the private marketplace is similar to the customization of the cobranded web sites described below with respect to FIGS. 32-44. The account manager 112 also customizes 304 the private marketplace based on the business needs of the private marketplace owner 104. This customization may include establishing networking capabilities and Internet bandwidth or filtering the marketplace database 110 based on the types of services required or the desired quality of the vendors 106. In step 306, the private marketplace manager 107 and the account manager 112 of the central server 130 preauthorize the private marketplace users 108. The preauthorization of the private marketplace users 108 is discussed in greater detail in the description of FIGS. 4 and 5 below. The account manager 112 then creates 308 a list of vendors 106 that will have access to the private marketplace. The private marketplace manager 107 may then edit 310 the list of vendors 106 and add 312 vendors to the list. Establishing a list of vendors 106 for the private marketplace is discussed in greater detail in the description of FIGS. 6-8.

FIG. 4 is a preferred embodiment of a user interface for the private marketplace user registration. The registration form allows the private marketplace user 108 to provide a user name 402, password 404, and contact information 406. The user name 402 and password 3104 ensure that only registered users will be able to access the private marketplace. Once the user has registered, the user may access the private marketplace by entering a user name and password. In a preferred embodiment, the user name will be tied to a specific level of access. For example, an officer of the private marketplace owner 104 may have access to all projects in the marketplace while a general user 108 will have access to only those projects managed by that user 108.

FIG. 5 is a preferred embodiment of the user interface for the login procedure. In a preferred embodiment, in order to access the private marketplace, the user 108 must login using this interface. This user interface provides a space for the private marketplace user 108 to enter his user name 502 and password 504. By pressing the login button 506, the private marketplace user 108 will send this information to the central server 130, and the central server software 114 will verify the user name and password and allow access to the private marketplace.

Through the management of contact lists of vendors, the private marketplace owner 104 may streamline the procurement of services by using the lists to invite bids from a subset of the entire pool of preferred vendors.

FIG. 6 is a preferred embodiment of a user interface for entering contact information of a vendor 106. Through this user interface, the private marketplace users 108 may enter the name 602 and contact information 604 for preferred vendors 106. In the Notes section 606, the private marketplace users 108 may also add information about the vendor 106 such as previous projects received from the vendor, expertise of the vendor, or the vendor's quality of work. The private marketplace user 108 may also add the vendor's 106 contact information to a pre-established list 608 of vendors. The list of vendors may be sorted based on the above information such that the user 108 may request quotes from the vendors most appropriate for a given project.

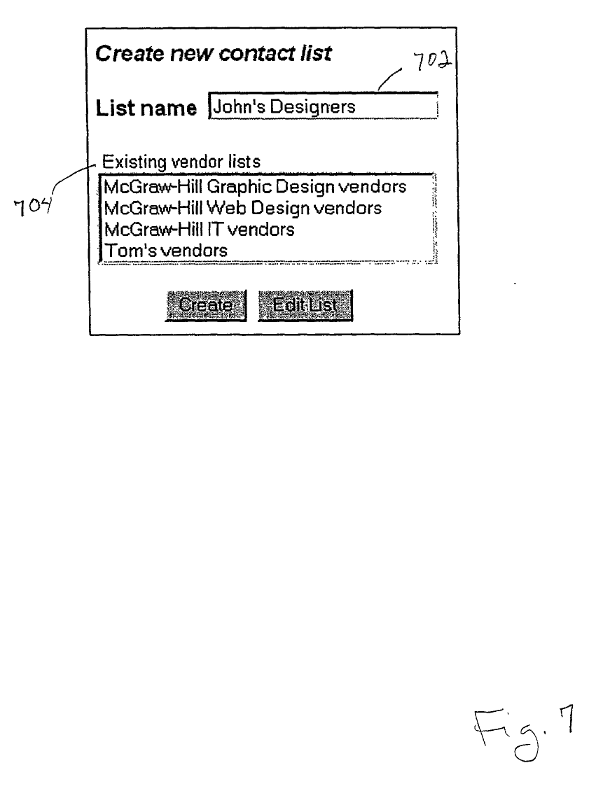

FIG. 7 is a preferred embodiment of the user interface for creating a new list of vendors. The user interface provides a space for the private marketplace user to enter the name 702 of the list. The user interface also provides a list 704 of the existing pre-established vendor lists.

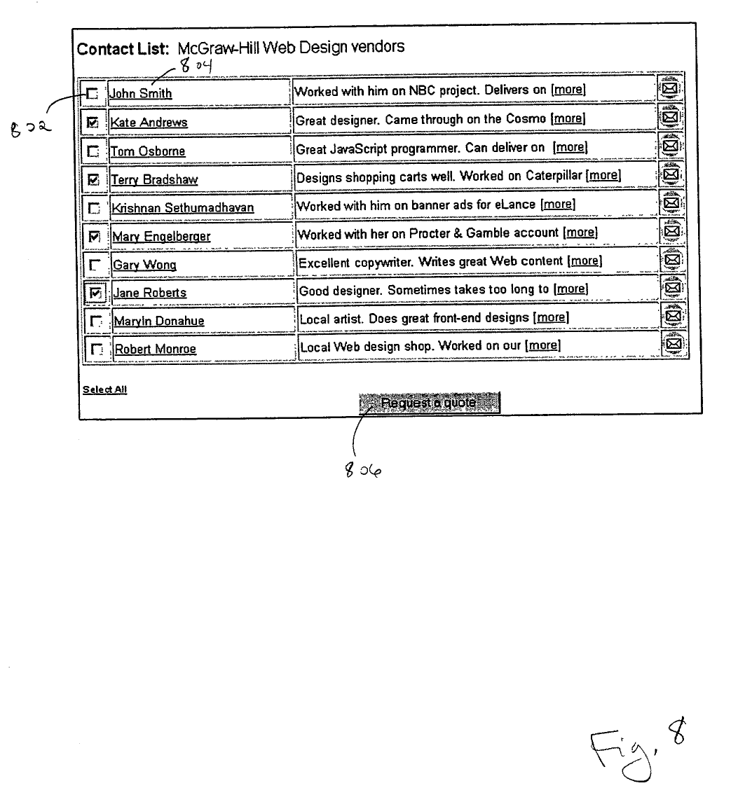

FIG. 8 is a preferred embodiment of a user interface for accessing a contact list of vendors 106. The private marketplace user 108 may use this interface to edit the list of vendors or to request a quote from one or more of the vendors on the list. By checking the boxes 802 next to the name 804 of the vendors, the private marketplace user 108 may request a quote 806 from one or more of the vendors 106. The selected vendor information will be sent via the network 102 to the central server 130, and the central server software 114 will respond with the user interface for posting a new RFP.

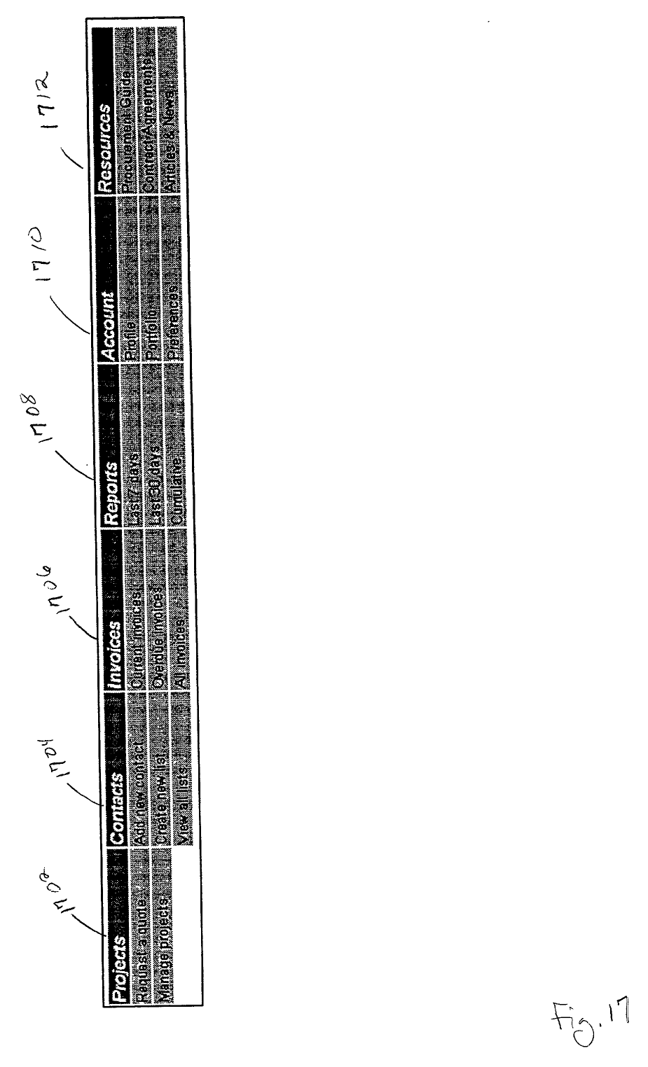

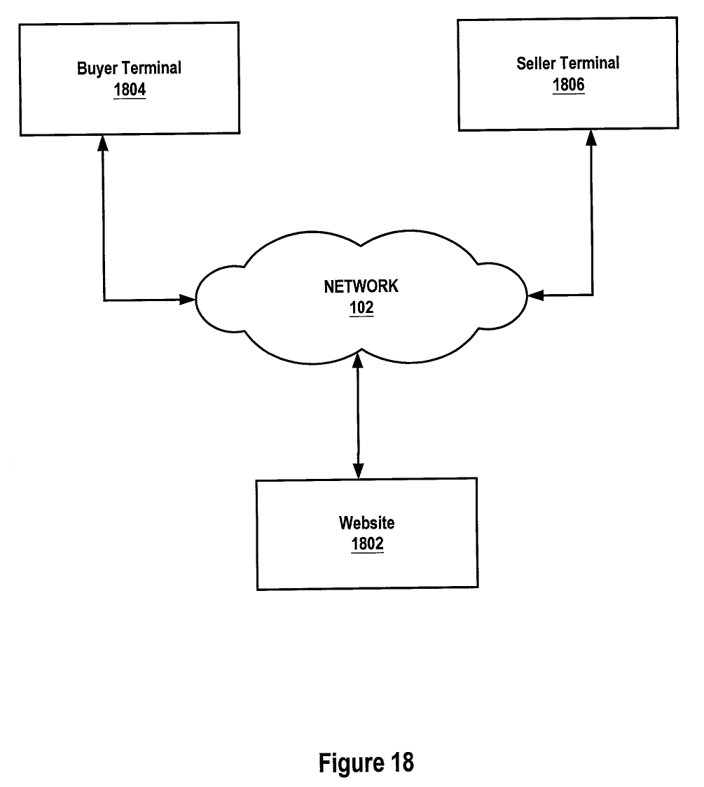

FIG. 9 is a flow diagram of a preferred embodiment for procuring services 204. The private marketplace user 108 invites 902 bids from a subset of the list of vendors. The subset may include all of the vendors on the specific list and may also include vendors that are not on the list. Alternatively, users 108 may request bids from vendors within the overall marketplace, similar to the online marketplace discussed below with respect to FIGS. 18-31. These invitations are sent via the network 102 in the central server 130 to the listed vendors 106. The private marketplace users 108 then receive 904 bids from the vendors 106. The users 108 evaluate these bids and choose 906 a winning vendor 106. As part of the evaluation of the bids, the users 108 and the vendors 106 may negotiate and clarify the terms of proposed agreements using private and public message boards to communicate.

Through various stages of the procurement process, users 108, as employees, may have to receive the approval of one or more of their supervisors. This process prevents abuse or misuse of the private marketplace. For instance, the supervisors may restrict personal use of the marketplace and may ensure that the services procured by the users 108 are beneficial for the private marketplace owner. Project approval may include various pre-designated approvals such as overall project approval, finance approval or executive sponsor approval. The approvals may be required, for example, before beginning the project, accepting one of the bids, and/or prior to invoicing and making payment to the vendor.

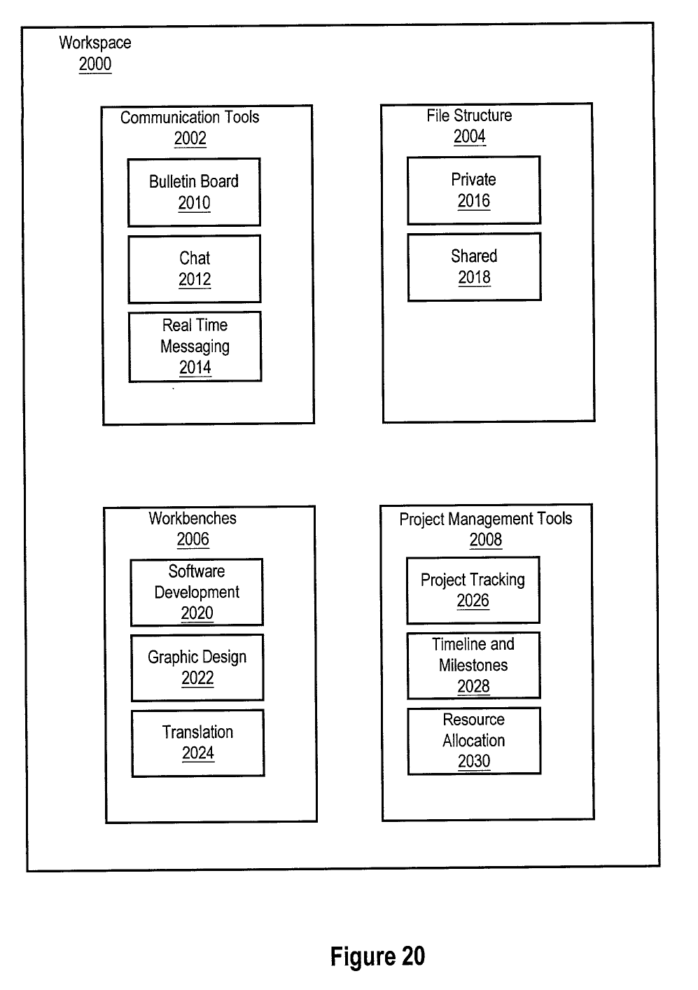

Once the private marketplace user 108 has chosen a particular vendor 106 to complete the service, the user and the vendor may collaborate 908 in a shared workspace. The workspace is an area unique to a given project where the vendor develops and delivers the services. The user may track the service as the vendor develops it within the workspace and then pick up the finished service from the workspace. The workspace is discussed in greater detail with respect to FIG. 20 below.

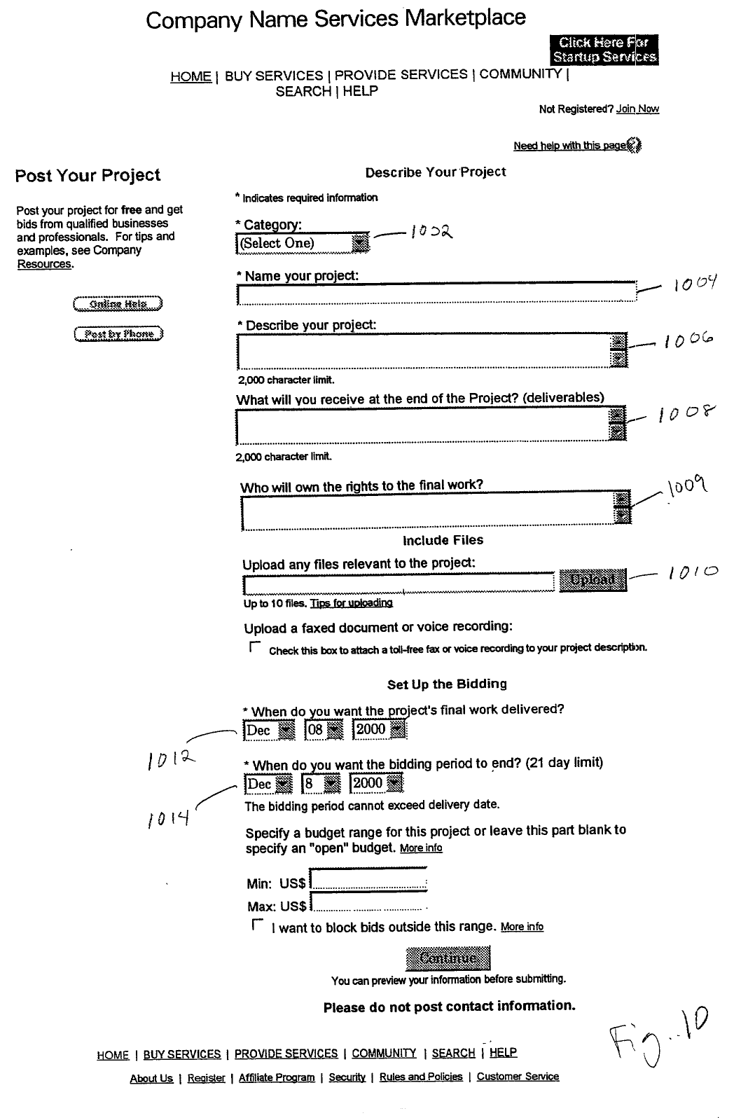

FIG. 10 is a preferred embodiment of the user interface for posting an RFP. The private marketplace user 108 may enter the category 1002 of the project, the name of the project 1004, and the description of the project 1006 in the spaces provided. The user may also enter the intended deliverables 1008, i.e., what the user expects to receive from the vendor 106 after the project is completed. In box 1009, the user 108 may enter who will own the rights to the final work. The ownership rights may lie in the user 108, the marketplace owner 104, the vendor, or a third party. Through this user interface, the private marketplace user 108 may upload 1010 files necessary to complete the given project. The user interface allows the private marketplace user 108 to enter the deadline 1012 for completion of the project and to enter the end date 1014 of the bidding period.

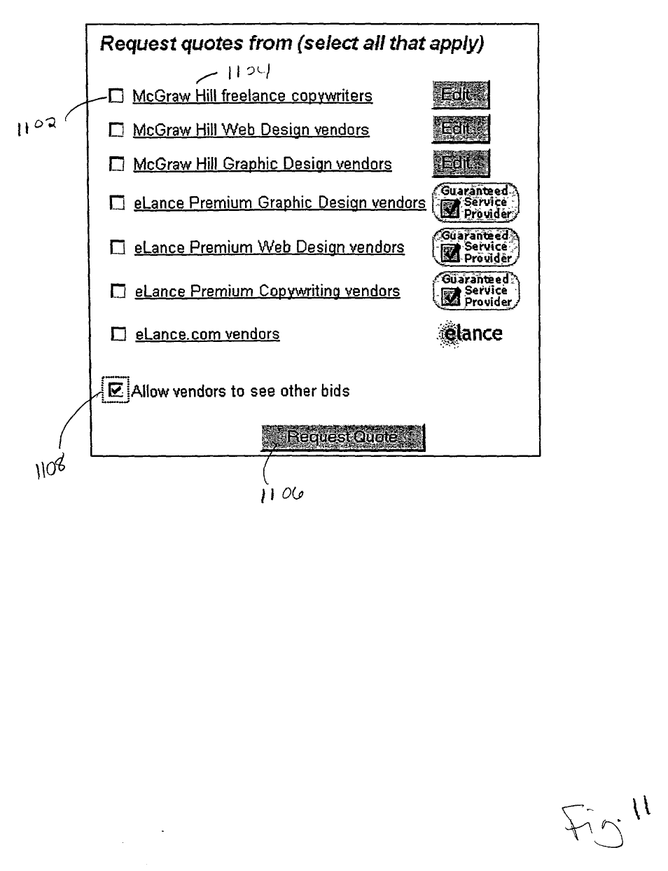

FIG. 11 is a preferred embodiment of the user interface for requesting quotes, or inviting bids from specific vendors. Once the private marketplace user 108 has posted a project, that user may request a quote for that project from any number of vendors 106. By checking the box 1102 next to the name 1104 of the vendor list and pressing the Request Quote button 1106, the private marketplace user 108 will send the posted project to the selected vendors 106. The private marketplace user 108 has the option of allowing the vendors to see other bids by checking box 1108. The user 108 thus, has control over whether the vendors bid against each other or submit blind bids.

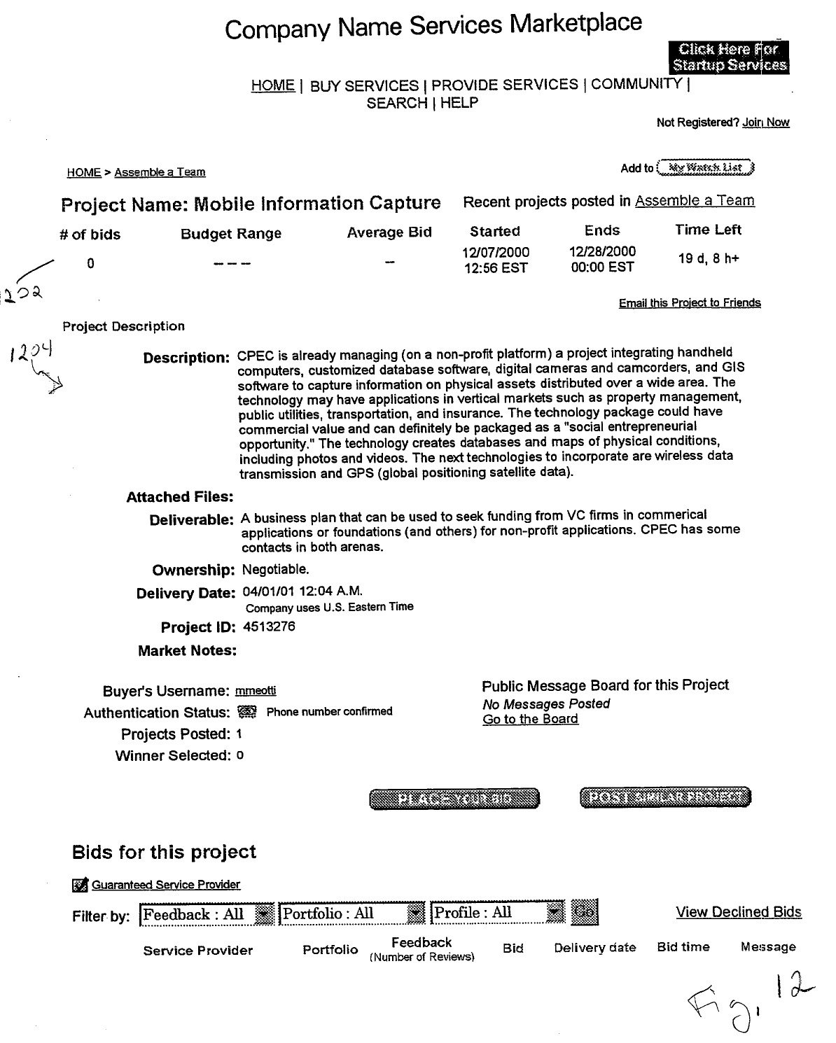

FIG. 12 is a preferred embodiment of the user interface for posted projects received by the vendors 106. The vendor 106 may view a list 1202 of the posted projects or a detailed description 1204 of a particular project.

FIG. 13 is a preferred embodiment of the user interface for adding a personal message 1302 to a posted project. This personal message would be added to the detailed description that is viewed by the vendor 106.

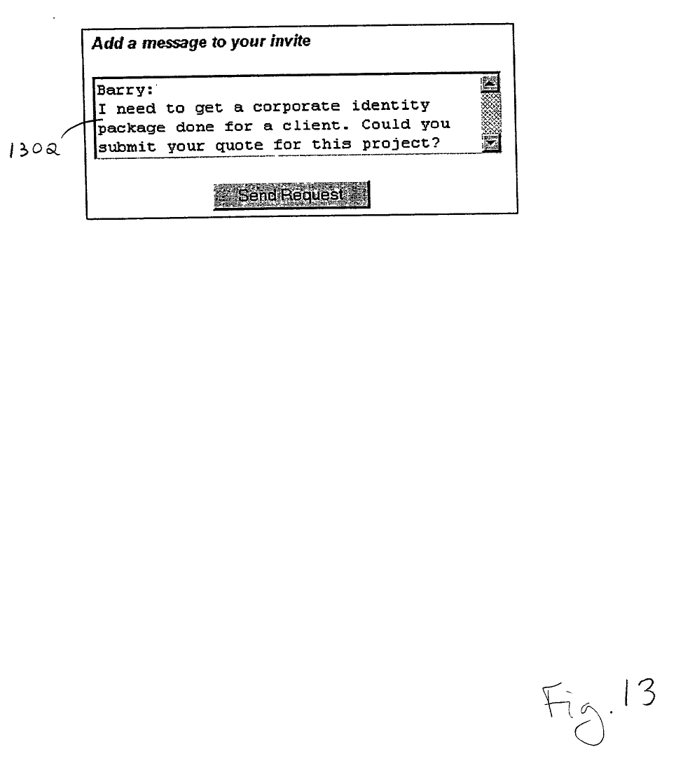

FIG. 14 is a preferred embodiment of a user interface for entering a bid on a posted project. Through this user interface, the vendor 2806 may enter the amount charged for the service 1402, the date 1314 the vendor can complete the service, and a summary of the vendor's proposal 1406 for completion of the service. The user interface also provides a space for the vendor to upload a file 1408 to be viewed by a user requesting the service.

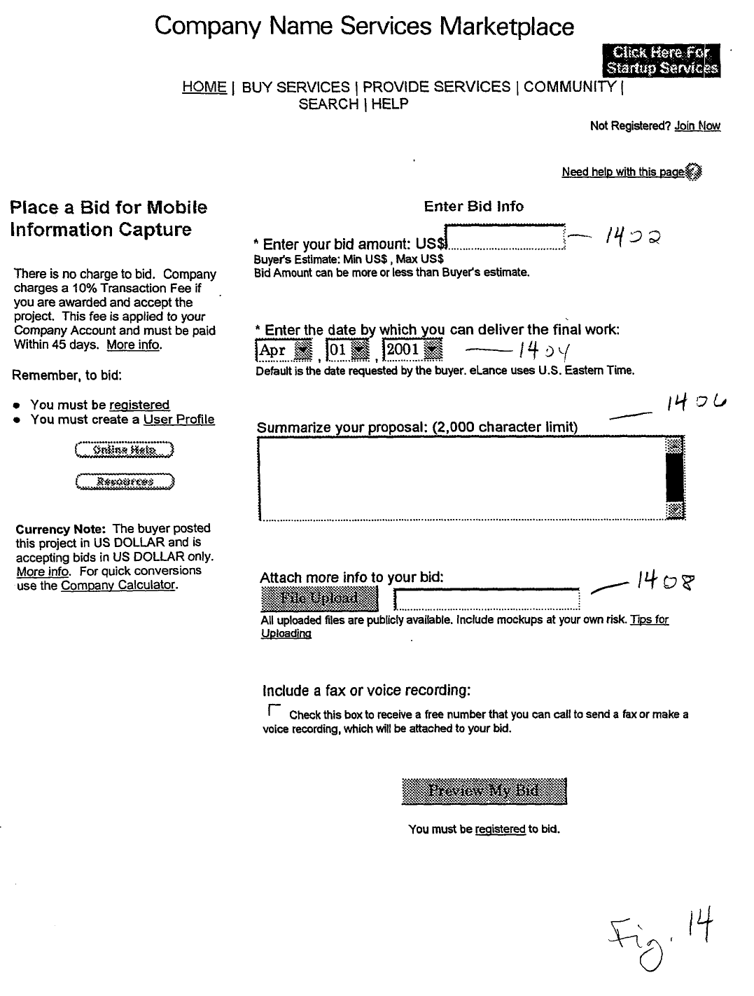

FIG. 15 is a preferred embodiment of a user interface displaying the current bids 1502 for a given project. The private marketplace user 108 or the vendor 106 may access this list.

The list may be filtered by feedback 1504, by portfolio of the vendor 1506, or by the profile 1508 of the vendor. Alternatively, all of the bids may also be viewed. The list of bids includes the name of the vendor 1504 making the bid, a link to the portfolio 1506 of that vendor, a feedback rating 1508 for that vendor, a link to the reviews 1508 of that vendor, the vendor's bid 1510, the delivery date 1512 for the service, and the time 1514 the bid was placed. The user interface also displays any comments 1516 from each vendor, which may include the vendor's relevant technology and experience.

FIG. 16 is a flow diagram of a preferred embodiment of the payment process 208. After completing the service, the vendor 106 sends 1602 an invoice to the central server 130. The central server 130 consolidates 1604 all invoices for a given private marketplace owner 104. The central server 130 then sends a consolidated bill to the private marketplace owner 104. The private marketplace owner 104 then sends a payment 1606 to the central server 130, and the central server disburses 1608 this payment to the various vendors 106. The sending of the invoices and payments may be done either electronically or via hard copy and regular mail.

FIG. 17 is a preferred embodiment of the dashboard user interface. The dashboard includes access to projects 1702, contacts 1704, invoices 1706, reports 1708, account 1710, and resources 1712. The private marketplace users 3104 may access any of the options on the dashboard in order to monitor and manage the private marketplace. Under the Projects heading, the private marketplace user 108 may request a quote or manage open projects. Requesting a quote will link the private marketplace user 108 to the Post a Project form. Manage open projects will allow the private marketplace user 108 to access a list of all current posted projects. Under the Contacts heading, a private marketplace user 108 may add a new contact, create a new list, or view all lists of contacts. Under the Invoices heading, the private marketplace user 108 may access current invoices or overdue invoices.

Under the Reports heading, the private marketplace user 108 has access to customized reports based on the business needs of the private marketplace owner 104. The reports may be viewed, for example, as a cumulative summary, a summary of the last thirty days, or a summary of the last seven days. Access to the various types of reports may vary based on the registration of the marketplace user 108. For instance, a user 108 with a supervisory position within the marketplace owner 104 may have access to different types of reporting than a user who is not a supervisor.

In a preferred embodiment, the types of reports include requested reports, planning reports, and performance measurement reports. The requested reports may include, for example, reports with information about vendors or projects; customer feedback reports, which may include customer comments; activity reports, which may include marketplace statistics such as how many projects were opened in a given period of time, how many vendors were invited to bid, or how many vendors entered bids; aging reports, which may include the number of projects completed, overdue, or pending; project resource retention rate reports including retention rates for vendors and statistics on the number of contractors on various projects; and billing reports including purchase order summaries listed by department, business unit, etc. The planning reports may include project management reports including sorted lists of project managers, project request approvers, and project budget approvers. The performance measurement reports may include reports on project scheduling, whether predetermined milestones were met, whether budgets were met, etc. It is understood that this list of reports is not exhaustive and that any number of additional reports may also be used to manage the marketplace in a manner most beneficial for the marketplace owner.

### Online Marketplace

FIG. 18 is a diagram of a system including a server hosting a website 1802 (hereinafter “website”), a buyer terminal 1804, a seller terminal 1806 and a network 102, such as the Internet. The buyer terminal 1804, the seller terminal 1806 and the website 1802 are all connected via the network 102. As a result, the buyer and the seller can communicate via their terminals 1804, 1806 using the website 1802. In this embodiment, the buyer terminal 1804 and the seller terminal 1806 may include one or more computer systems such as desktop computers, laptop computers, network computers, handheld data storage devices, wireless communication devices, cellular telephones, etc. A preferred embodiment of the present invention is implemented in a client-server environment as shown herein. The Internet is one example of a client-server environment. However, any other appropriate type of client-server environment, such as an intranet, a wireless network, a telephone network, etc. may also be used. The present invention is not limited to the client-server model and could be implemented using any other appropriate model. The described embodiment uses the worldwide-web, although other protocols may be used and other, newer versions of the web may also be used.

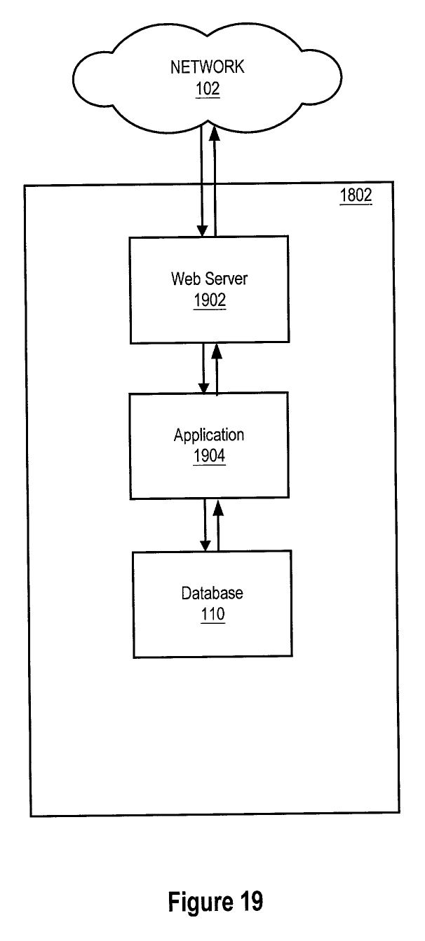

FIG. 19 is a diagram of the website 1802. The website 1802 includes a web server 1902, an application 1904 and a database 110. The web server 1902 provides the connection to the network 102. The application 1904 implements the steps necessary to communicate with the buyer terminal 1804 and the seller terminal 1806. The application 1904 further generates information based on the communications with the buyer terminal 1804 and the seller terminal 1806. The database 110 includes memory storage of information received from the buyer terminal 1804 and the seller terminal 1806 and information generated by the application 1904 The generation and storage of information is discussed in greater detail below.

Although, in this embodiment, the server 1902 is shown as a single unit, it may include one or more computer systems. The generation and storage of information as described herein is preferably performed by instructions stored in a memory and executed by a computer processor, although the invention is not limited to this embodiment. These instructions may be stored on a computer-readable medium, such as a floppy disk, CD ROM, or any other appropriate storage medium.

FIG. 20 is a block diagram of a data structure for a collaborative workspace 2000. The application 1904 generates a unique workspace 2000 for each project that is initiated using the website 1802. The workspace 2000 is stored in the database 110. The workspace 2000 is where sellers develop and deliver services. Buyers can track the service as the seller develops it within the workspace 2000 and then can pick up the finished service from the workspace 2000. The workspace 2000 includes communication tools 2002, a file structure 2004, workbenches 2006, and project management tools 2008. The communication tools 2002 facilitate communications between the buyer and the seller and may include one or more bulletin or message board systems 2010, real time chat room systems 2012, and real time messaging systems 2014. The communication tools 2002 may also include any other means of communication that is implemented over a network such as integrated online meetings with real time document sharing and annotation, web tours, and application sharing. The buyer and the seller may use the communication tools 2002 to discuss the details of their project anytime after the application 1904 has initiated the project.

The file structure 2004 includes private folders 2016 and shared folders 2018. The file structure is discussed in more detail in the description of FIG. 21.

The workbenches 2006 may include at least software development 2020, graphic design 2022, and translation 2024 each of which may be used by the seller for the development of services. The workbenches 2006 may also include web-enabled versions of routine-use products, productivity tools for efficient work, and industry-specific workbenches.

The industry-specific workbenches are specially designed for the type of service provided. For instance, for a software services provider, the workbenches may include telnet access to a remote host, a file editor for editing text files, a compiler, a source code control system for tracking source code versions, a debugging environment for debugging remote code., a test environment for evaluating software, deployment and remote hosting of software applications, and access to other third party tools. Another example of industry-specific workbenches lies in graphic design services. Workbenches for this area include application such as AutoCAD and Photoshop, graphic filters and software plug-ins for industry standard software tools, tools for inserting digital watermarks to prevent piracy, access to third party tools, and access to collections of clip-art, photographs, caricatures, etc.

Since the services are being developed and delivered online and may involve multiple vendors working together on one or more projects, project management tools are used to facilitate the organization of these multiple, simultaneous projects. The project management tools include tracking project status in summarized and detailed forms, tracking project timelines and milestones, and resource, cost and time allocation.

Buyers and sellers may also use the workspace 2000 even when they are not currently transacting through the online marketplace. For example, if a seller does not currently have a buyer for a service, the seller may still develop the service and create and store files in the workspace 2000. Similarly, when buyers and sellers are not currently transacting they may still maintain a virtual office within the website 1802. Buyers may store details on their service needs, preferences, transaction history, billing and preferred vendors. Sellers may store details on skills and certification, reputation, transaction history, billing and preferred buyers. This information is maintained in the database 110 of the website 1802.

FIG. 21 is a diagram of one embodiment of a file structure 2004. The file structure 2004 includes folders 2102 and files 2104 organized in a manner commonly found on computer systems. Each folder 2102 may contain one or more additional folders 2102 and/or files 2104. The files 2104 and folders 2102 are organized in a hierarchical manner 2106 that facilitates easy access to each file 2104. The file structure 2004 may be the same for both the private workspace 2016 and the shared workspace 2018. The workspace 2000, however, is not limited to this file structure 2004 and may also use other methods of organizing stored files. When accessing files 2104 in the workspace 2000 through the use of the file structure 2004, the buyer and seller may use various operators to manipulate the files 2104. These operators may include creating new files, editing files, storing links to web pages in the form of URLs, uploading and downloading files from/to a local computer, renaming files, and moving files. The ability of the buyer and seller to use these operators may be restricted for certain files or certain versions of a file. For instance, access to files 2104 in a private folder 2016 is restricted to either the buyer or the seller depending on which of them owns the files. Access to files 2104 in a shared folder 2018 may be accessible by both the buyer and seller of a given project but not by all users of the marketplace.

A seller may also specify that a certain file be accessible to other sellers or be publicly available.

FIG. 22a is a screen shot of the user interface for posting a RFP. This page 2202 includes a project description area 2204, an upload area 2206, and a bidding area 2208. These areas contain user prompts 2210 and areas for the user to enter information 2212 based on these prompts 2210. In the bidding area 2208, the user may select a marketplace for the project. The user may choose this marketplace from a selection of categories 2209 or may define another category for the project. The page 2202 may also contain RFP wizards 2214. The wizards 2214 are used to customize the prompts 2210 in the project description area 2204, upload area 2206, and bidding area 2208. The wizards 2214 vary by category 2216 and subcategory 2218. By activating a wizard 2214 in a certain category 2216 or subcategory 2218, the user can have access to prompts 2210 that are customized to that category 2216 or subcategory 2218. In this manner, the user is able to post an RFP with information that is tailored to the type of project that the user is posting.

FIG. 22b is a user interface for posting a fixed-price service offer. The seller, or service provider, provides the information for the fixed-price service offer. Like the interface for posting a RFP, this interface contains user prompts 2210 and areas for the user to enter information 2212 based on these prompts 2210. The areas include the type of service offered 2220, the service provider's specialization 2222, the price per unit for the service 2224, the delivery time 2226, and a description of the service 2228. The interface also includes an upload area 2230 where the service provider may attach files for the buyer to evaluate. The interface also contains a preview button 2232 that allows the seller to see the fixed-price service offer before it is posted.

FIG. 22c is a user interface for placing a bid on a project. This interface, like the previous interfaces, also contains prompts 2210 and areas for the user to enter information 2212 based on these prompts 2210. The areas include the amount of the bid 2234, the date for delivering the service 2236, and a summary of the proposed service 2238. Like the interface for posting a fixed-price service offer, this interface contains an upload area 2230 and a preview button 2232. The interface also includes a box 2242 that the user may check in order to attach a fax or voice recording to the bid.

FIG. 23a is a screen shot of the user interface for per project workspaces. As described in the discussion of FIG. 20, the application 1904 automatically creates a workspace 2000 for each project that is initiated. In this embodiment, the user interface includes a private folder 2016 and a shared folder 2018. The shared folder 2018 contains files 2104 accessible by both the buyer and the seller. The private folder 2016 contains files 2104 accessible by either the buyer or the seller, but not both. The user may move back and forth between the shared and private folders 2018, 2016 in order to access the desired files 2104. The user may also access a private message board through link 2302. The user interface for the workspace 2000 includes information 2304 about the project, which may include the project name, the size of the files uploaded in the workspace 2000, and the date the workspace 2000 was last modified.

FIG. 23b is a screen shot of an interface to a shared folder 2018. From the shared folder 2018, the user may access any shared files 2104. The user may use the operators 2308 to manipulate the files in the folder 2018. The operators 2308 may include creating a folder, or manipulating a file by copying, moving, renaming, deleting, downloading, uploading, or adding comments to that file.

FIG. 23c is a screen shot of a private message board. The private message board includes a text entry area 2304 and an upload area 2206. Once the user enters a message in the text entry area 2304 and posts the message, the message may be accessed from the message retrieval area 2306. The message retrieval area 2306 may include information such as the user's name, the title of the message, and the time the message was posted. Both the buyer and the seller have access to the private message board. The user may use the upload area 2206 to include files 2104 with the user's message.

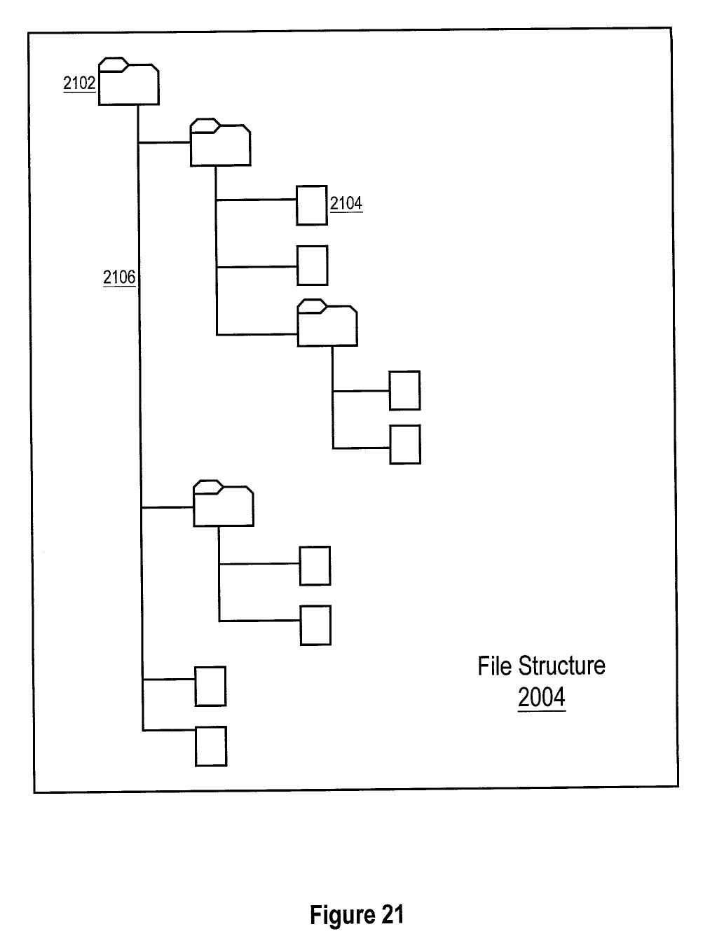

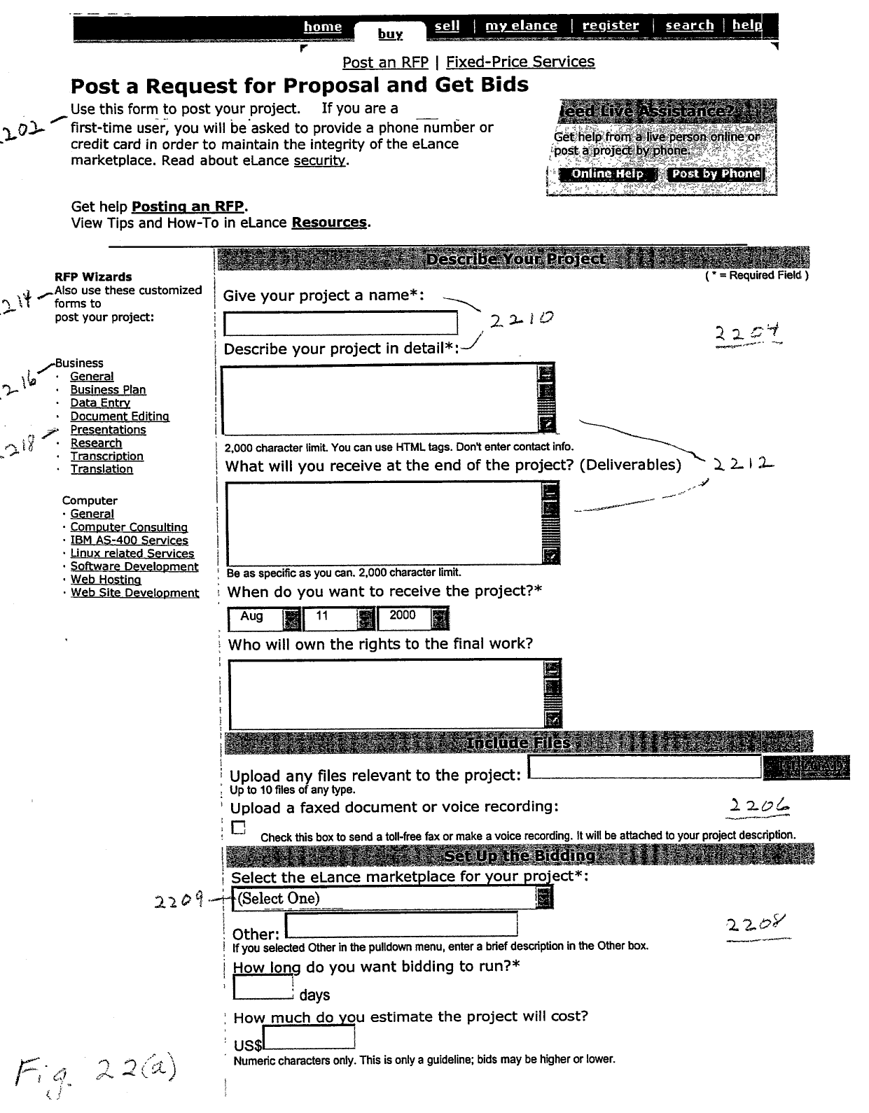

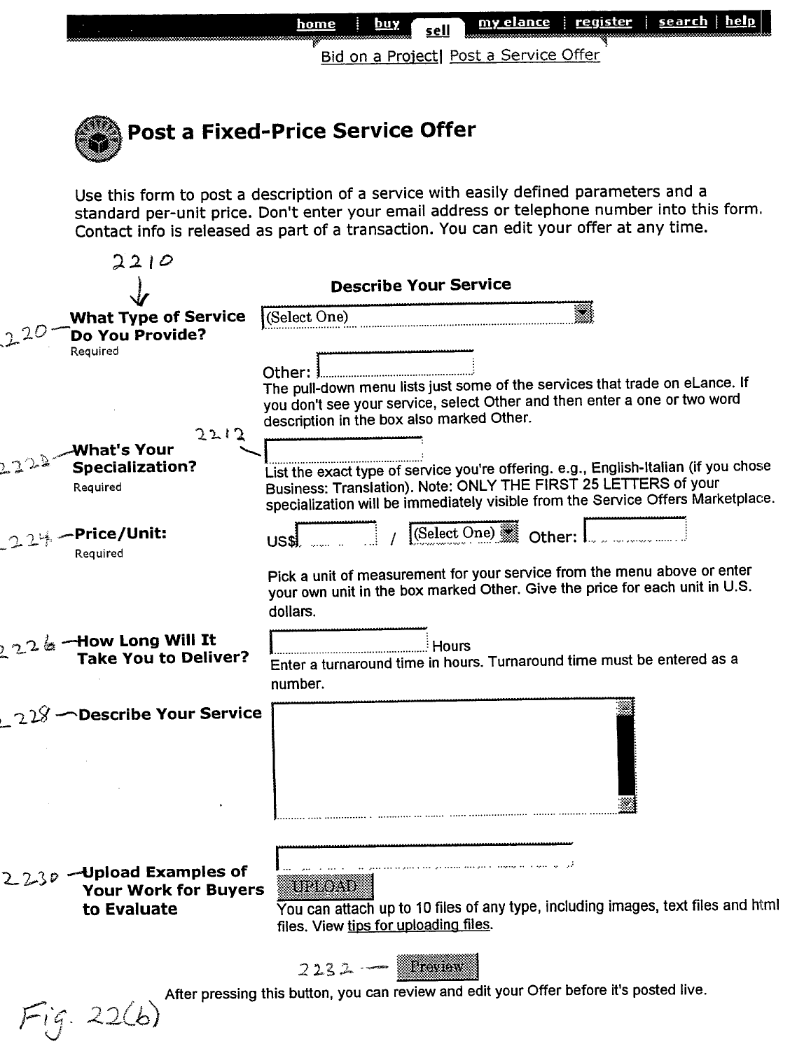

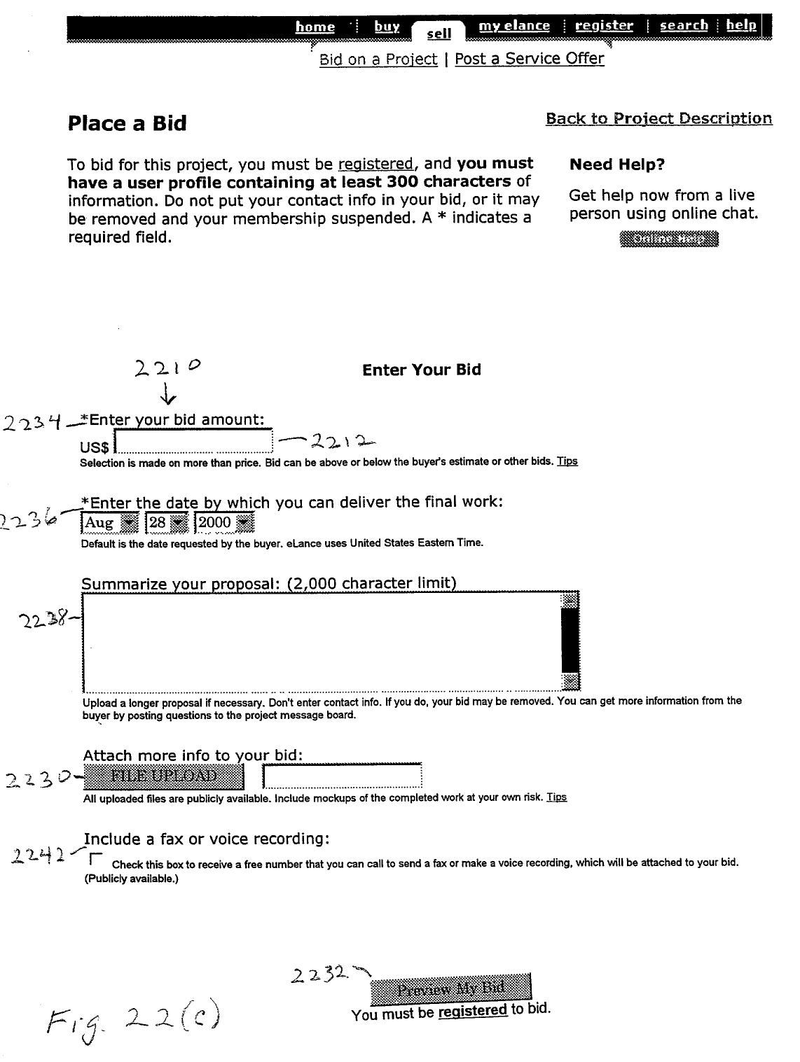

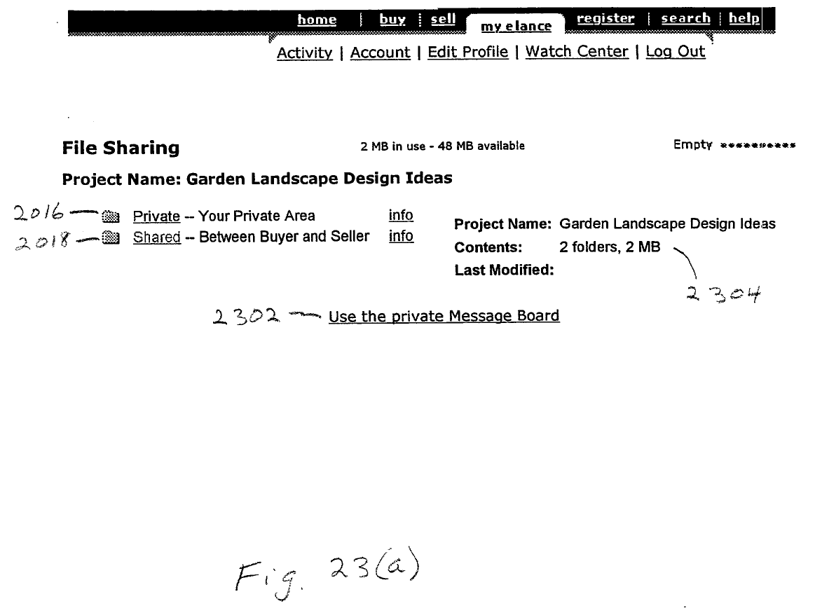

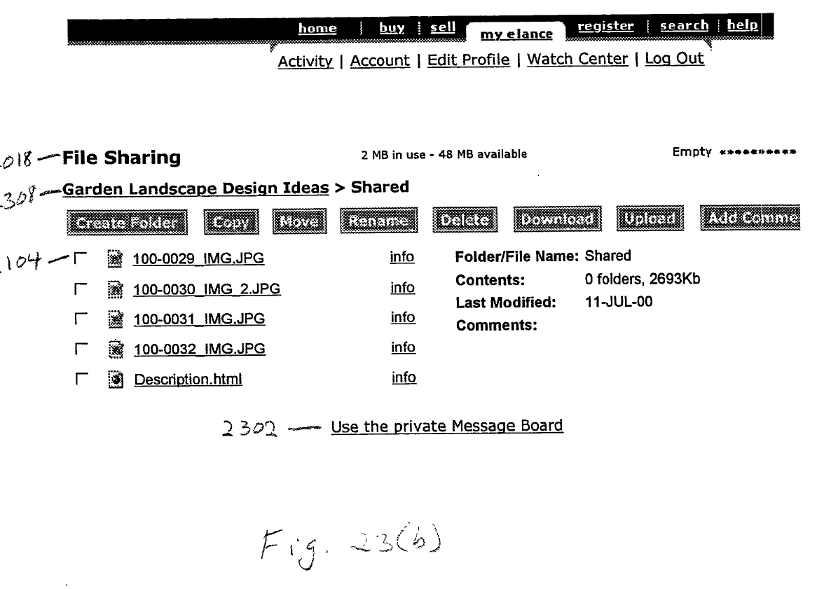

FIG. 24 is a user interface showing a list 2400 of current requests for proposals (RFPs) available on the website 1802. Each RFP is submitted by a buyer. The list 2400 includes information about each RFP, such as the project ID 2402, the project name 2404, the category 2406 and subcategory 2408, the initial estimate 2410 for the project, the number of bids 2414 made on the project, the amount of the average bid 2414, the time left 2416 to bid on the project, and the buyer's name 2418. The seller may browse this list of RFPs and use the information contained in the list to choose one or more projects on which to bid.

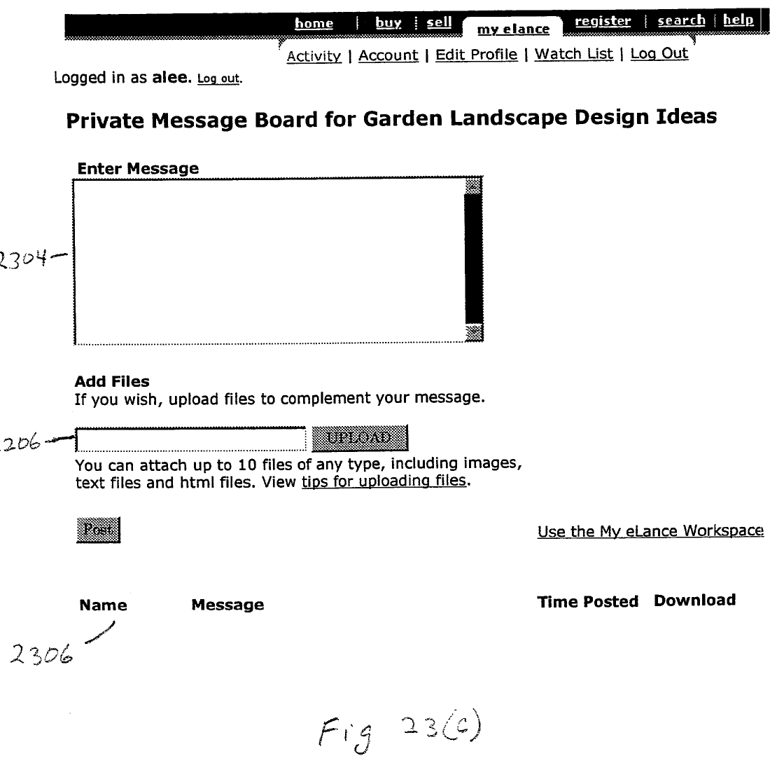

FIG. 25 is a list 2500 of current fixed-price services available on the website 1802. Each entry in the list 2500 is a service offering submitted by a seller. The list 2500 includes information about each offered service, such as the project ID 2512, the available actions 2504 to take on the project, the category 2506 and subcategory 2508 of the project, the specializations 2510 concerning the project, the price 2512, the unit 2514 of measurement for the price, the seller's name 2516, and the rating 2518 of that seller. The buyer may browse the list 2500 of services and use the information provided to help with the buyer's purchasing decision. The buyer may also choose one of the actions 2504 to find out more information about the offered service or to purchase the service.

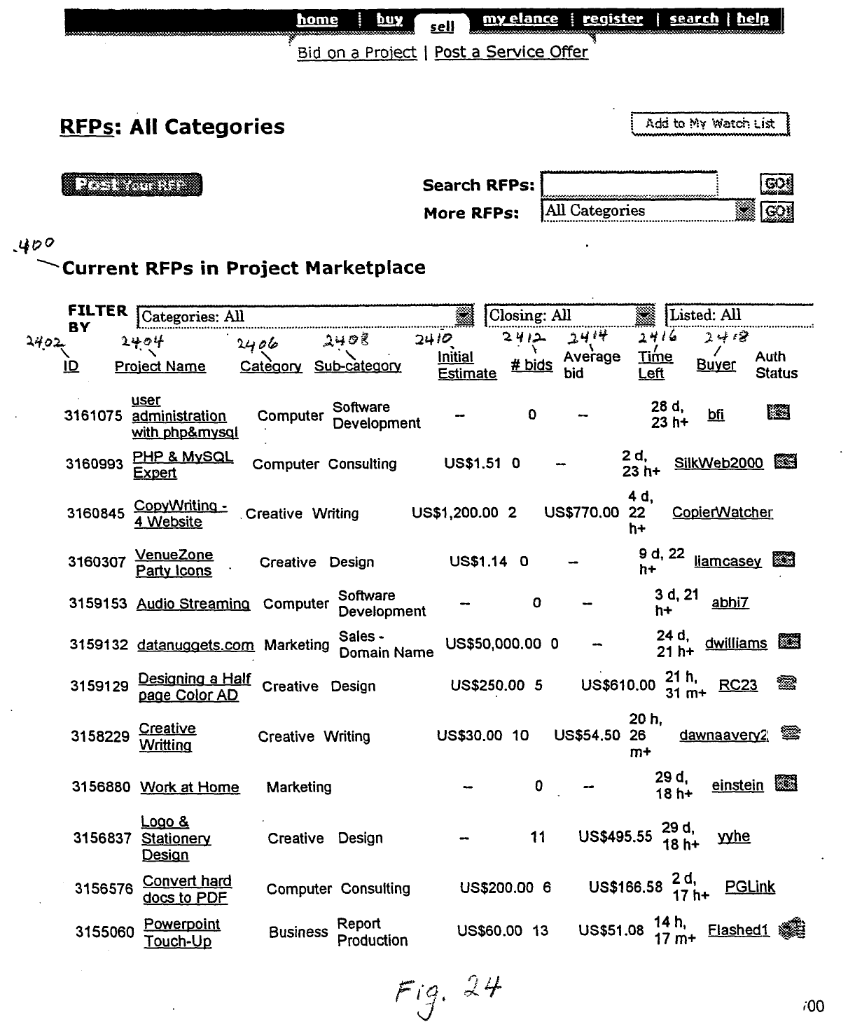

FIG. 26 is a user-specific page 2602 on the website 1802. The user may be both a buyer and seller of services, thus there is space for both the user's buying activity 2604 and the user's selling activity 2606. As a buyer, the user may post 2608 a project, i.e., an RFP, or the user may browse 2610 the fixed-price services offered by sellers. As a seller, the user may bid 2612 on an RFP, or the user may post 2614 a fixed-price service offer. Once the user has initiated any buying and/or selling activity, information about that activity is displayed in the appropriate space 2604, 2606. The information includes the project ID 2616, the bid ID, 2618, the name 2620 of the project, the type 2622 of project, the seller's name 2624 or the buyer's name 2638, the status of the project, 2626, the actions 2628 available for the project, access to the workspace 2603, and access to any messages 2632 concerning the project. As a buyer, the user has the option to make a payment 2634 and as a seller the user has the options to send an invoice 2636 to the buyer. With the user-specific page 2602, the user is able to access all projects in which the user is involved as either a buyer or a seller.

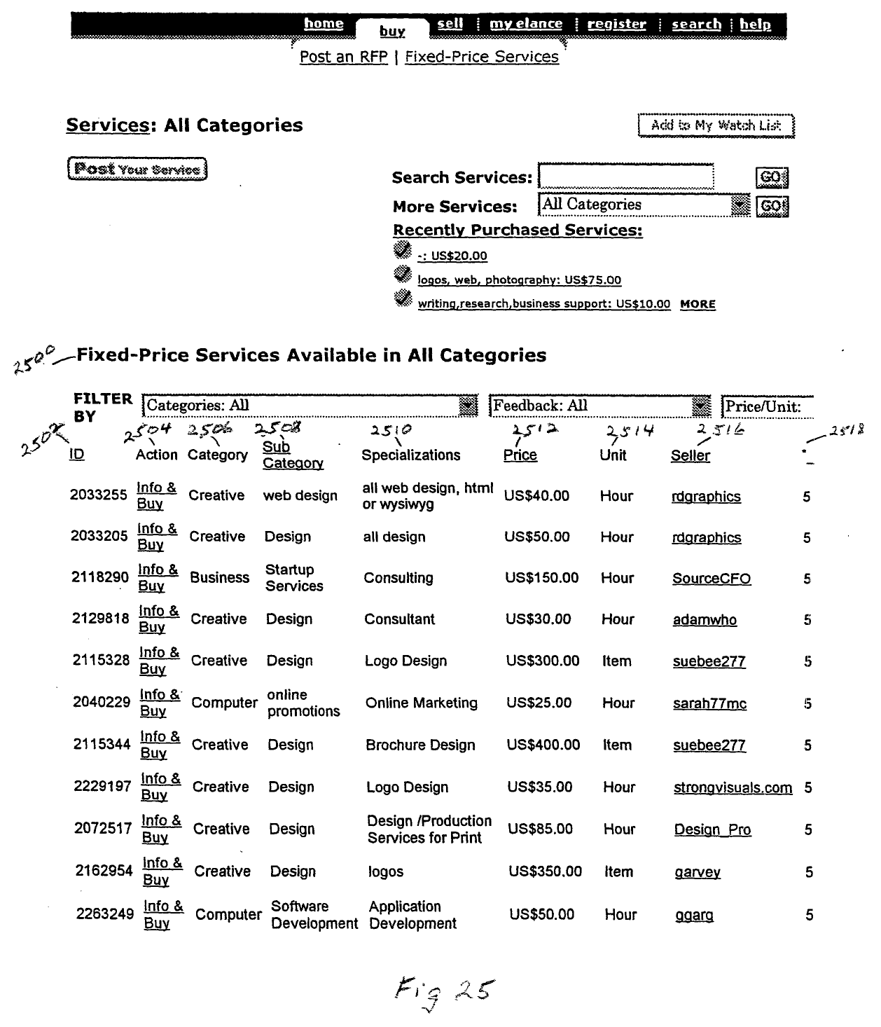

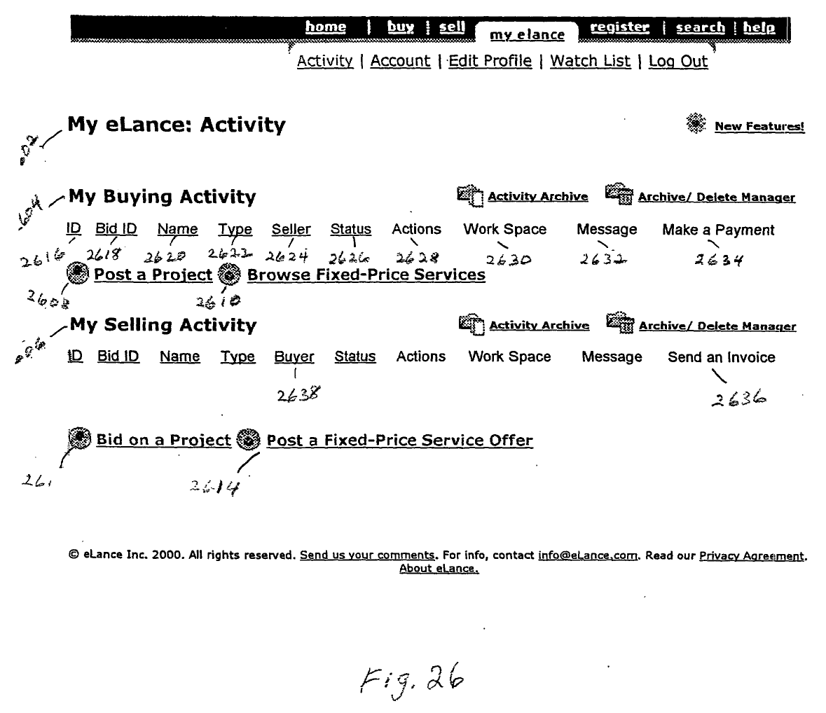

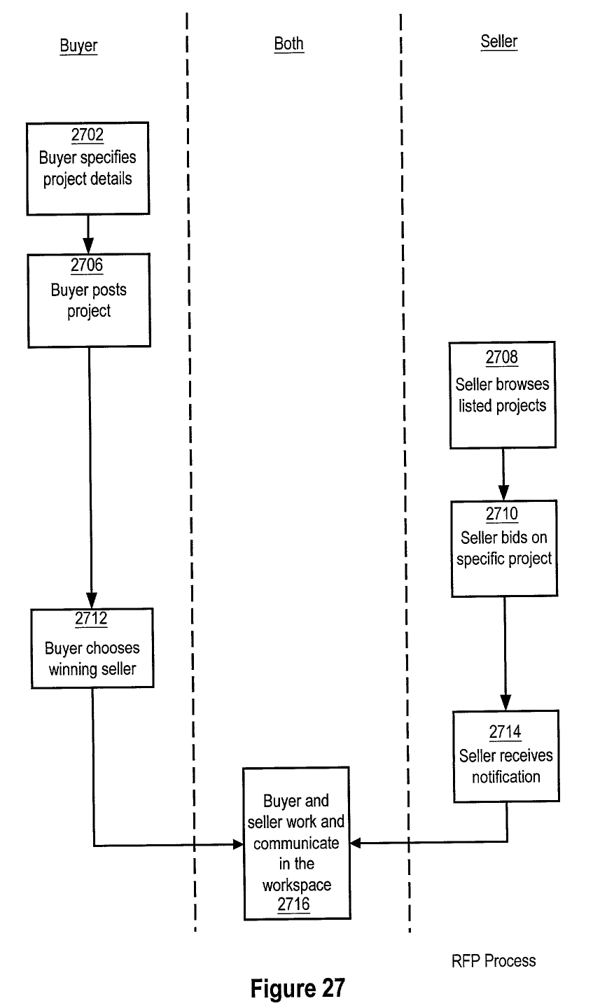

FIG. 27 is a flow diagram of the RFP process. This process is initiated by the buyer. First, the buyer specifies 2702 the project details. The project details may include a project name 2404, a description of the service that the buyer is requesting, the category 2406 and subcategory 2408 for the project, desired pricing 2410, and timelines 2416. The buyer may also upload relevant files or voice recordings as part of the project details. The buyer then posts 2706 the project. Once the buyer posts 2706 the project, the application 1904 adds the project to the list 2400 of current RFPs on the website 1802. Next, the seller browses 2708 the listed projects. The seller may then participate in an auction for a project by bidding 2710 on that project. The buyer chooses 2712 one or more winning sellers, and these sellers receive 2714 notification of the buyer's choice. The seller may then accept the project. Once the seller has accepted the project, the buyer and seller may work and communicate 2716 in the workspace 2000.

The auction may be a regular RFP auction or a Dutch auction. In a regular auction, the buyer specifies the bidding duration, and then sellers may bid on the project. Unless the buyer extends the bidding duration, the auction automatically closes when this duration is reached. In a. Dutch auction, the buyer chooses more than one seller to perform the service. In a preferred embodiment, the sellers will perform the service for the same price. The buyer does not have to specify that more than one seller will be selected but has the option to choose more than one seller at any point in the process after the RFP is posted.

FIG. 28 is a flow diagram of the commodity process. For commodity services, buyers do not need to run an auction. The seller offers services for purchase by specifying 2802 category, price, quantity, availability, turnaround time and other parameters that the seller updates periodically. In the preferred embodiment, the buyers specify 2804 the category and price of the desired service, and the acceptable feedback rating for the seller. The buyer may also specify other constraints such as turnaround time, desired quality, etc. Within the website 1802, the application 1904 uses optimization techniques to automatically satisfy as many of the buyer's constraints as possible. The optimization process is discussed further below. The application returns 2808 matching sellers and a list of all sellers. The buyer then chooses 2810 a seller from the optimized list. The buyer specifies 2812 the job details and the file attachments, which are then loaded by the application 1904 into the workspace 2000 for the project. The application 1904 notifies 2814 the seller of the buyer's choice. The buyer and seller work and communicate 2816 in the workspace 2000.

For both custom and commodity services, as the process unfolds, the application 1904 proactively alerts the market participants to relevant events, such as whether the auction for a project has closed, whether the seller has accepted or declined a project, and whether a project is completed. The described embodiment can contact the buyer and seller with email, pager, phone, fax, mobile phone, etc. The options for being contacted are specified by the user. For instance, a seller may choose to be called at a certain phone number during certain times of the day. This process of reaching the buyer and seller through means other than the network 102 allows the website 1802 to bridge the offline and online worlds by notifying the participants in the real world of events that occur in the online world.

Market participants that transact with each other using the website 1802 are able to rate their counter-parties. These ratings are stored in the database 110. In a preferred embodiment, buyers and sellers are each rated among several distinct criteria. The feedback may include whom a buyer or seller has worked with in the past, what comments the rater had, and even contact information to facilitate using the rater as a reference. Since the buyer and seller are collaborating on the project, the feedback is bilateral with the buyer rating the seller and the seller rating the buyer. The feedback is accessible to all users of the marketplace. The feedback is not averaged for the specific user rather each project has unique feedback even if the seller or buyer has been involved in more than one project. This feedback system is an effective counter measure to fraud in the marketplace. Reputation is important in services because services frequently involve recurring transactions and not onetime transactions. Vendors will realize the importance of developing a positive reputation in order to win more auctions and also increase their pricing. The reputation they develop will also dissuade venders from doing transactions off-line as then those transactions will not add to their reputation.

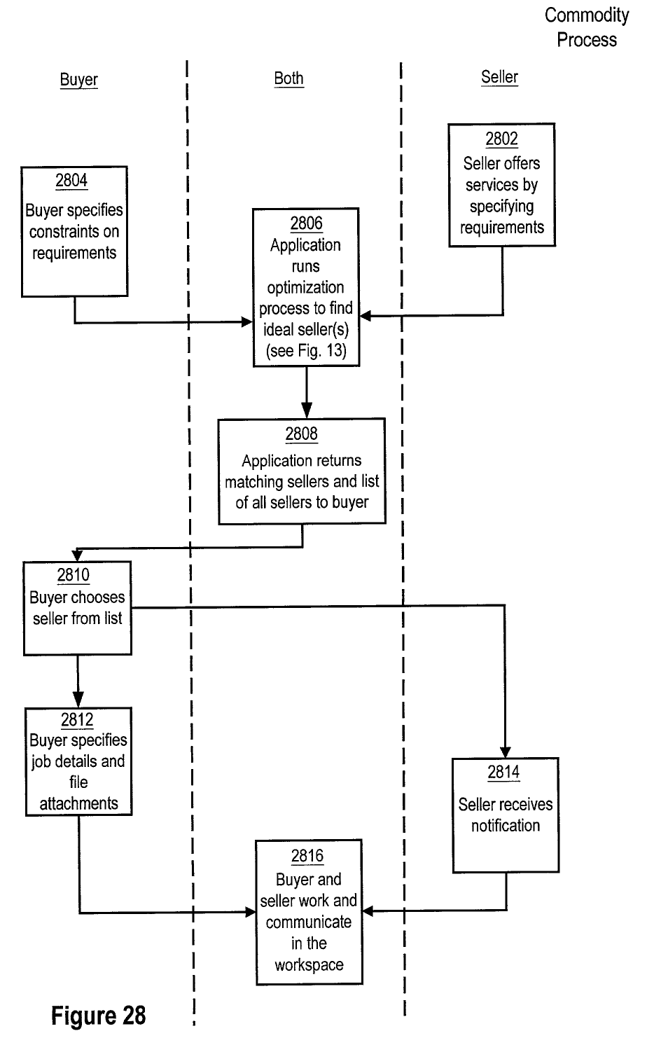

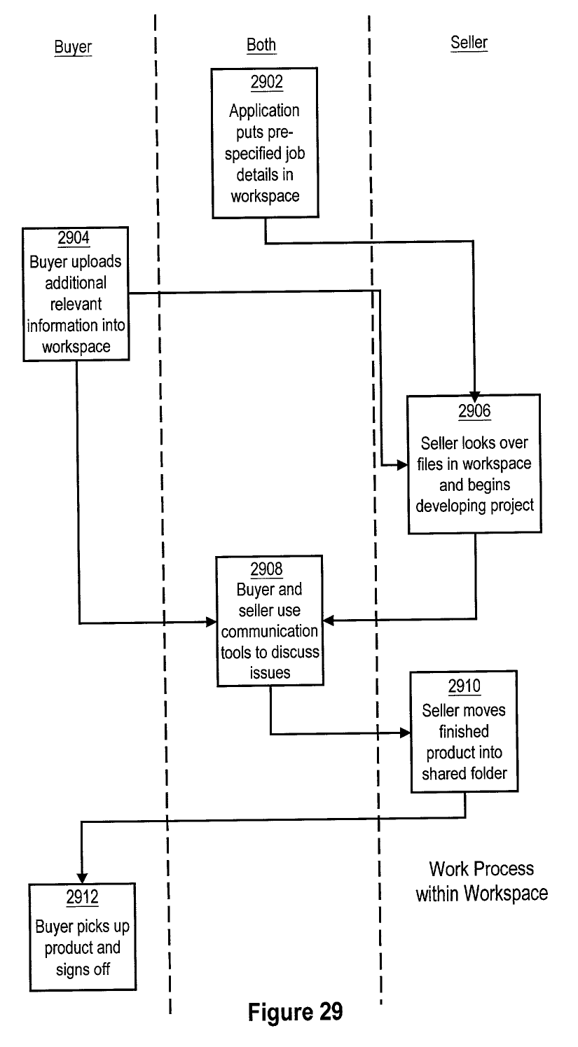

FIG. 29 is a flow diagram of an example work process within the workspace 2000. The application 1904 puts 2902 the job details and file attachments that were previously specified 2812 by the buyer into the workspace 2000. The buyer may then upload 2904 additional, relevant information into the shared or private folder 2018, 2016 in the workspace 2000. The seller then looks over 2906 the files in the shared folder 2018 of the workspace 2000. The seller next begins developing the project using development tools and storing files in the seller's private folder 2016. During the development time, the buyer and seller may use communications tools 2002 to discuss 2908 issues surrounding the service development. Once the project is completed, the seller moves 2910 the finished product into the shared folder 2018 of the workspace 2000. The buyer then coordinates with the seller regarding payment for the services, picks up 2912 the released product from the workspace 2000, and signs off. The seller can also develop the project on his local machine and upload the results to the workspace, but this loses much of the advantage of having the workplace, since the buyer is less able to track the progress of the project.

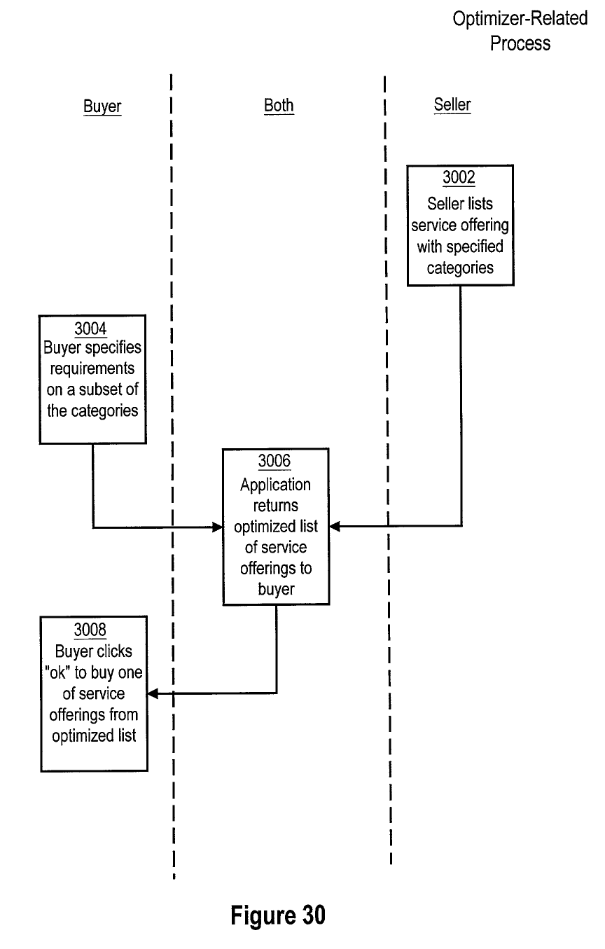

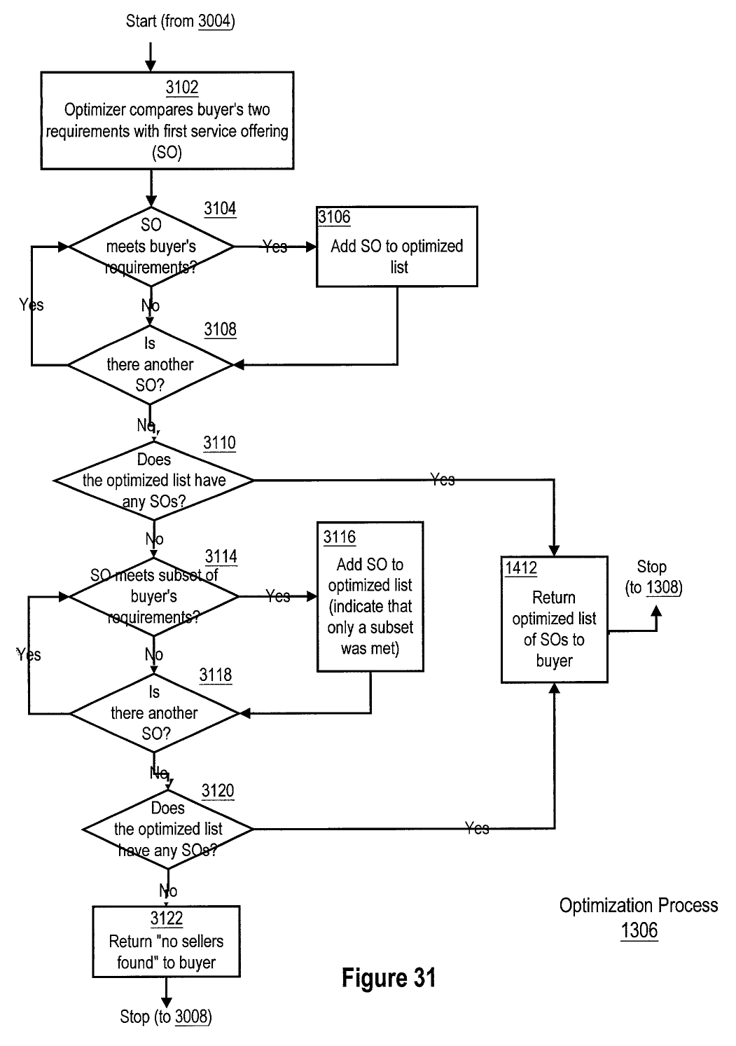

FIG. 30 is a flow diagram of the optimizer-related process used for commodity services. This process is used to assist the buyer in choosing a service offering for purchase. The process is initiated by the seller when the seller lists 3002 one or more offerings. These offerings are displayed in the list 2500 of fixed-price services shown in FIG. 25. The seller specifies a number of requirements which may include price, quantity, ownership rights, and delivery time for each offering (see FIG. 22). The buyer specifies 3004 the requirements on a subset of these categories, e.g., the buyer may specify 3004 a required price and quantity or a required quantity and delivery time. The requirements may also be in ranges, e.g., delivery anytime in August or price $15-$20 per hour. The application then returns 3006 the optimized list of service offerings. This optimization process is discussed below in detail in connection 30 with FIG. 31. The buyer clicks 3008 “ok” to buy one of the service offerings from the optimized list.

FIG. 31 is a flow diagram of the optimization process 3006. The optimizer compares 3102 the buyer's two requirements with the first service offering. If the service offering meets 3104 both of the requirements of the buyer, then that service offering is added 3106 to the optimized list of service offerings. If the service offering does not meet 3104 the requirements, then the application looks 3108 for another service offering. The application also looks 3108 for another service offering after a service offering is added 3106 to the optimized list. In both cases, if there is another service offering, then the application does the same comparison 3102 for the next service offering.

If there are no more service offerings, then the application checks whether the optimized list contains 3110 any service offerings. If the optimized list contains 3110 service offerings, then the application returns 3112 the optimized list of service offerings to the buyer. If the optimized list contains 3110 no service offerings, then the application again compares the buyer's two requirements with the first service offering. If the service offering meets 3114 one (or a subset) of the buyer's requirements, then that service offering is added 3116 to the optimized list. Optionally, the offering is noted on the list as having met only a subset of the requirements. If the service offering does not meet 3114 any of the buyer's requirements, then the application checks 3118 for another service offering. The application also checks 3118 for another service offering after adding 3116 a service offering to the optimized list. As above, if there is another service offering, then the application checks whether the next service offering meets 3114 one of the buyer's requirements.

If there are no more service offerings for the second comparison round, then the application checks whether the optimized list contains 3120 any service offerings. If the optimized list contains 3120 service offerings, then the application returns 3112 the list of service offerings to the buyer. If the optimized list contains 3120 no service offerings, then the application returns 3122 the message, “no sellers found” to the buyer.

### Cobranding

Cobranded web pages allow cobranding partners to enhance their cobranded site and earn additional revenue from their existing traffic. By linking to a central server (such as as marketplace data server), the cobranding partners allow their users to have access large amounts of marketplace data, from both the cobranding partner and from other cobranding partners. In addition, the described embodiment pays a cobranding partner for every user who registers through the cobranded site and for every user who buys a service.

Cobranding is achieved through an online tool that allows the partners to easily customize a central web site (such as a marketplace web site) to match the look and feel of their own site. The tool allows partners to change the color scheme and logos to match their own color scheme and logos, thus allowing the cobranded site to blend into the partner's existing web site. Users accessing a marketplace site via a partners cobranded site have access to all of the services available through the marketplace site, however they feel as though they are still within the partner's site. A cobranded page can also be embedded within a frame to add all of the functionality of the marketplace without sending users away from the partner's site.

The online tool also includes a link-builder tool that helps the partner create a link to the cobranded page from the partner's page. When a partner registers, he receives a unique referral ID (USER ID#). The link-builder tool automatically inserts the partner's USER ID# (also called an RID) at the end of the link to be placed on the partner's web site. Then, every time a user clicks the link to the cobranded site, the USER ID# number allows the central server to track which customers are registering and buying through that site.

FIGS. 32a) and 32(b) are diagrams showing that the cobranding concept allows aggregation of buyer and seller postings from cobranded web pages having appearances specified by the cobranding partners.

In FIG. 32(a) and FIG. 32(b), the system 3200 includes a first cobranded web page 3210, a second cobranded web page 3220, and a central server 130. A first user 3212 accesses the central server via website 3210 of a first cobranding partner, who has personalized the appearance of the cobranded web site. A second user 3222 accesses the central server via website 3220 of a second cobranding partner, who has personalized the appearance of the cobranded web site. Thus, the appearances of the first and second cobranded web sites to users 3212 and 3222 can be quite different. Users 3212, 3222 communicate with a central server 130 via the cobranded web sites 3210, 3220 displayed by the users' browsers. Users 3212, 3222 preferably access the central server via browsers connected to a network, such as the Internet, although other networks including proprietary networks and Intranets can be used. In this embodiment, the users' browsers can operate in conjunction one or more computer systems such as desktop computers, laptop computers, network computers, handheld data storage devices, PDAs, cellular telephones, etc. A preferred embodiment of the present invention is implemented in a client-server environment as described herein. The Internet is one example of a client-server environment, however, any other appropriate type of client-server environment, such as an intranet, a wireless network, a telephone network, etc. may also be used. The present invention is not limited to the client-server model and could be implemented using any other appropriate model. The described embodiment uses the worldwide-web, although other protocols may be used and other, newer versions of the web may also be used. A redirector may also be employed between the browsers and the central server.

In FIG. 32(a), user 3212 is a buyer who posts buyer-related information (such as request for proposal (RFP)) to the central database of central server 130 via first browser 3210. In FIG. 32(a), the second user is a seller who accesses the buyer's information and posts seller information (such as a response to a Request for Proposal (RFP)) to the central database of central server 130 via second browser 3220. This data is then accessed by the first user.

In FIG. 32(b), user 3212 is a seller who posts seller-related information (such as an offer for commodity services) to the central database of central server 130 via first browser 3210. In FIG. 32(b), the second user is a buyer who accesses the seller's information and posts buyer information (such as a response to an offer for commodity) to the central database of central server 130 via second browser 3220. This data is then accessed by the first user.

FIG. 32(c) is a diagram of a system including a central server and browsers cobranded web sites of two different cobranding partners. Each of the partners has one or more users. The figure shows how web content is sent to first browser 3210 and to second browser 3220, which each display the web content to their requesting users. In the figure, the content is not filtered. Thus, each user sees the same content, although the look and feel of the content may differ for the different cobranded web sites, as discussed below.

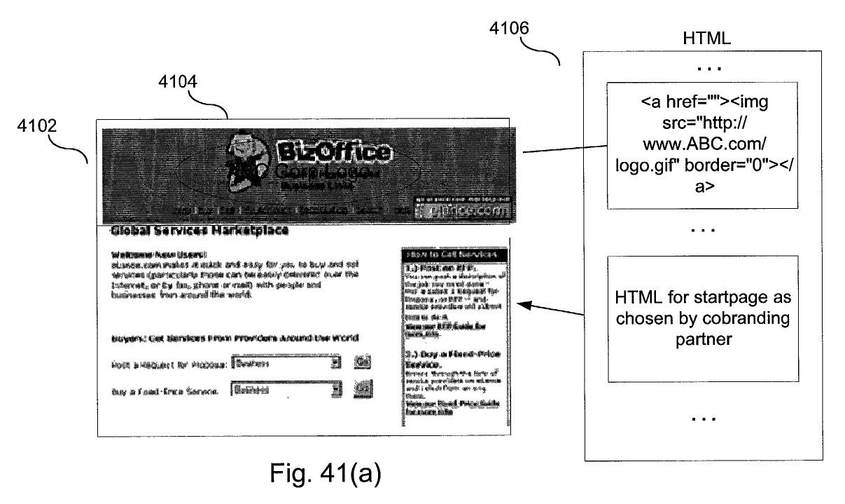

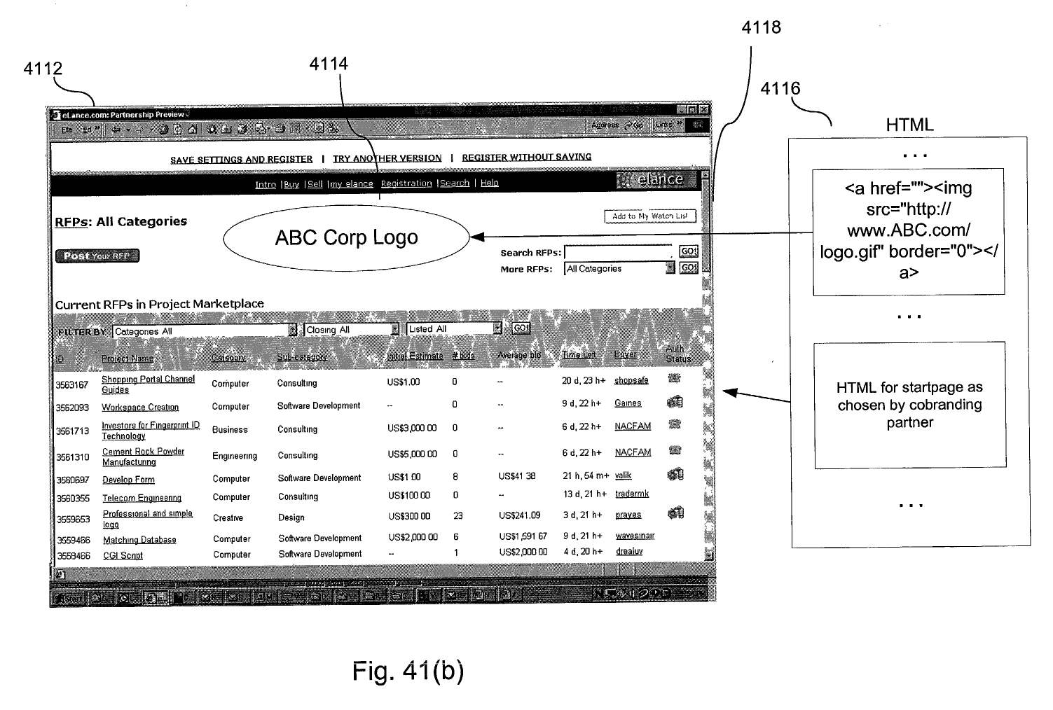

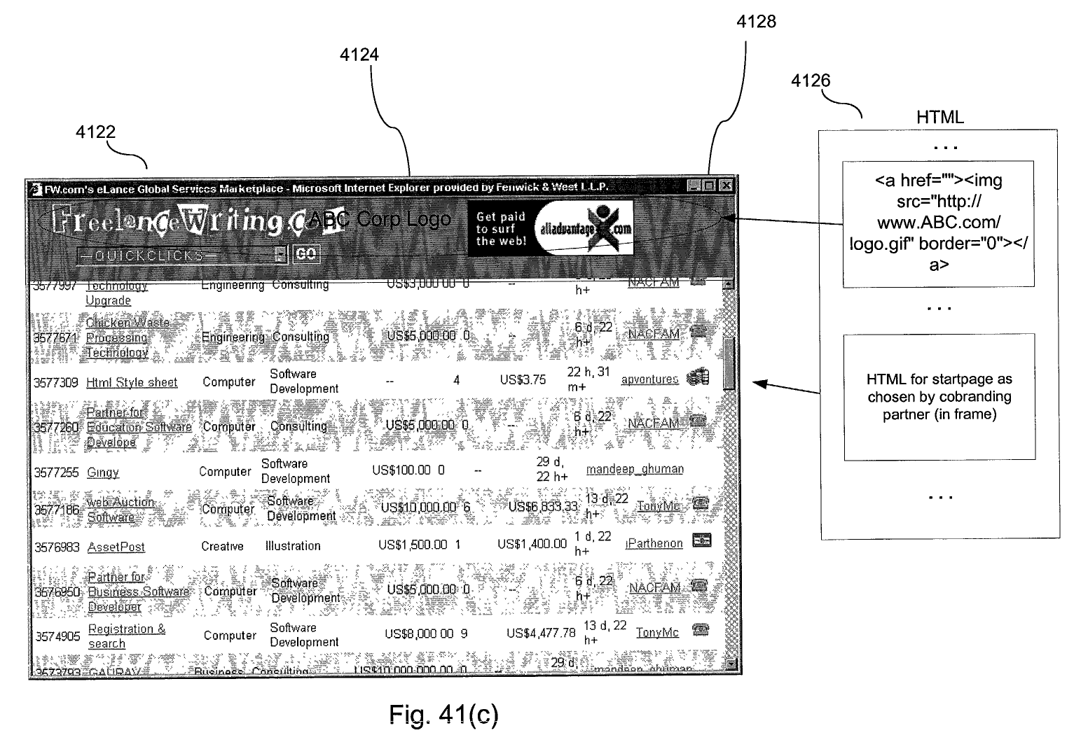

As discussed below, the web pages sent to browser 3210, 3220 are usually “branded” to reflect a look and feel specific to the cobranding partner. For example, a cobranded web page may contain the name and logo of a particular company if the cobranded page is owned by the company and directed toward company employees on an intranet. Examples of cobranded pages are shown in FIG. 41. Similarly, the web page sent to browser 3220 is usually “branded” to reflect a look and feel specific to the cobranding partner who is associated with the page. Thus, the look and feel of the pages sent to browsers 3210 and 3220 may be quite different, whether or not they contain the same content.

FIG. 32(d) is a diagram of a system in which cobranded sites of cobranding partners receive only a filtered subset of the information available from the central server. For certain cobranding partners, the content included in the web page is filtered before it is sent to the browsers 3210, 3220. For example, a browser operating on an intranet of a cobranding partner may be sent information that is filtered to include only posting from employees of the partner. As another example, the information sent to the browser may only reflect postings from employees of the partner, its subsidiaries and/or its own business partners. As another example, the information sent to the browser may be filtered to include only work related items (as indicated by keywords in the information), or to include only information from certain sources (such as the human resources department).

In the example, web content sent to first browser 3210 has been filtered by central server 130 in accordance with filters for the appropriate cobranding partner before it is sent. Similarly, web content sent to the second browser 3220 has been filtered by central server 130 in accordance with filters for a different cobranding partner before it is sent. Some of the filters may be predetermined and unchangeable (e.g., filters that only allow data entered by company employees). Some of the filters may be settable by persons connected with browser 3210 (for example, the users may be able to set additional filters from their browsers).

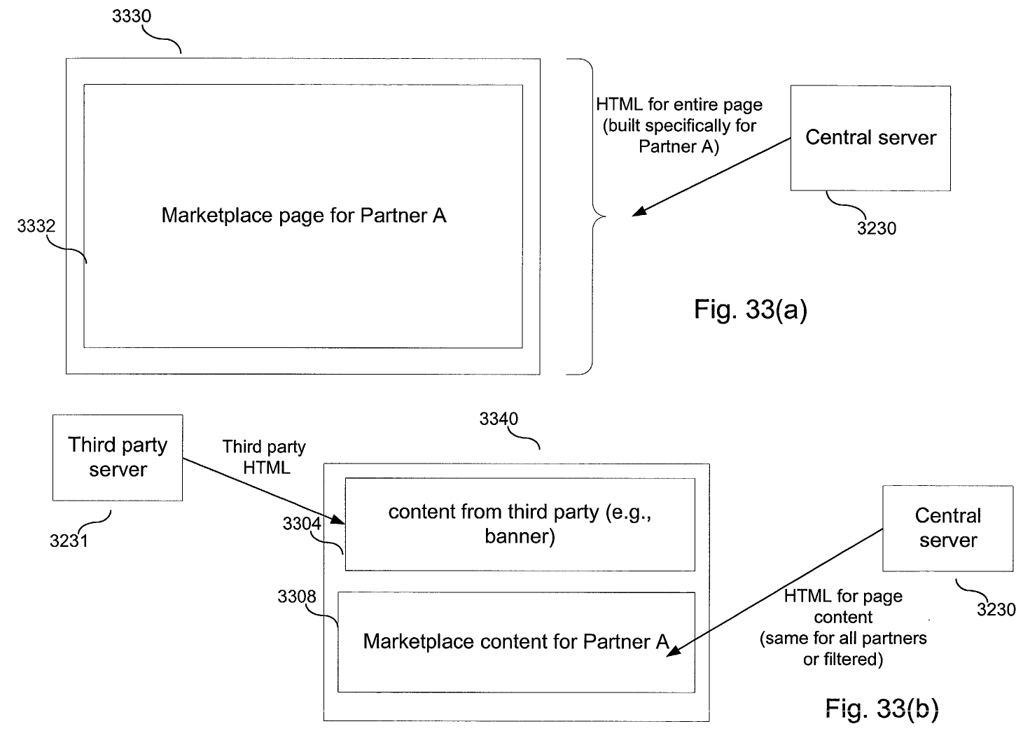

FIGS. 33(a)-33(c) show examples of content served from a central web server to cobranding partners in the described embodiments of the present invention. In FIG. 33(a), the server 130 builds a complete cobranded web page before returning it to the requesting browser, as described below. FIG. 33(b) shows an example in which central server 130 communicates with browser 3210, 3220 to deliver portions of web pages, such as specialized look and feel elements 3304, 3314 and/or specialized or filtered marketplace-related content 3308, 3318. In such a system, the browser 3210, 3220 generally makes multiple requests from server 130 in order to display a complete cobranded page. The browser must be configured to request the appropriate web content or the appropriate web content must be included in the html displayed by browser 3210, 3220. In the figure, content from a third party server (such as an advertisement) is also displayed on the page, along with content from central server 130.

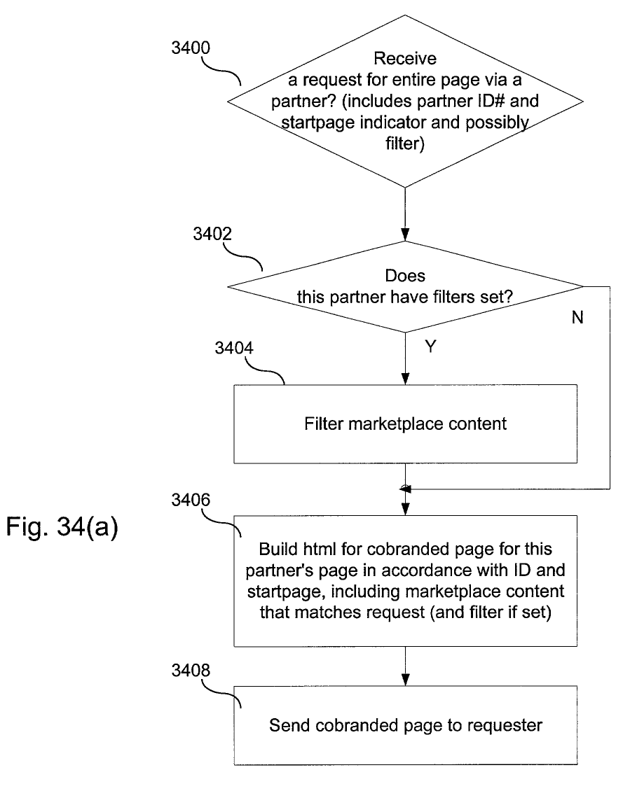

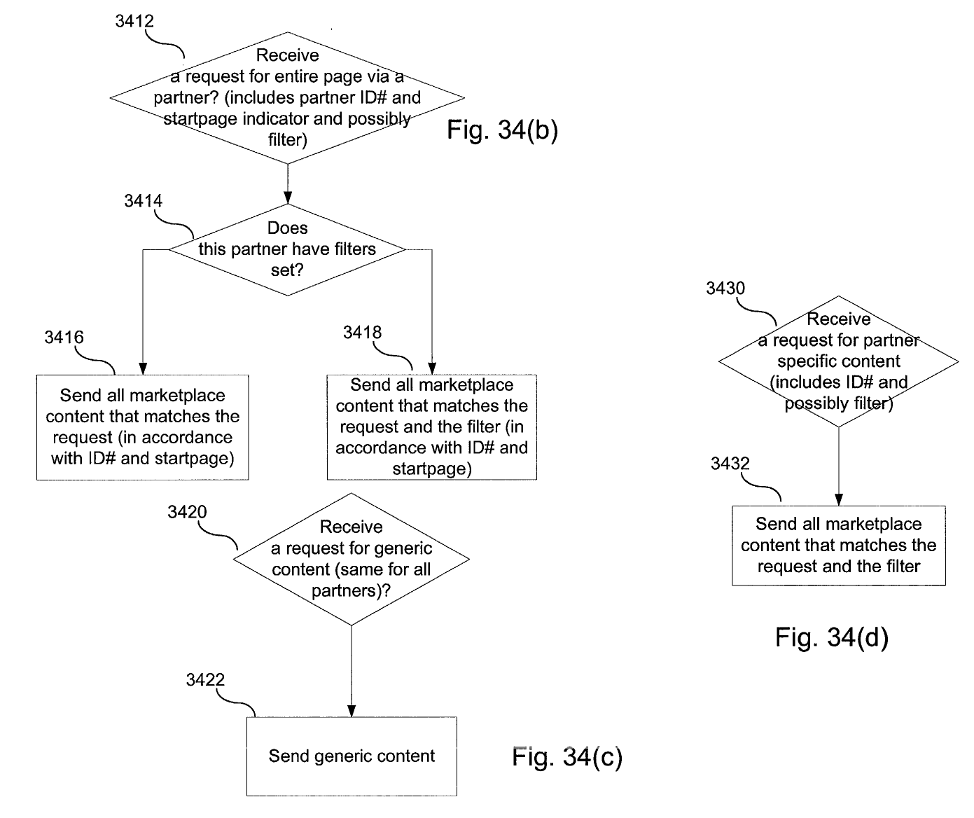

FIGS. 34(a)-34(d) are flow charts showing examples of methods performed by the central web server in response to requests for content from cobranding partners.

In element 3400, server 130 receives a request for an entire cobranded web page via a cobranding partner. Central server 130 determines the identity of the cobranding partner using any of several known methods, including checking for http parameters in the request, and checking a cookie on the browser. In the described embodiment, the request includes an USER ID# of the cobranding partner, as described below in more detail. The http parameters can also include additional parameters specified by the user or the server on a per request basis. If, in element 3404, the cobranding partner has indicated that it wishes to filter the marketplace content, central server 130 filters the marketplace data in database 110 and uses the data to build 3406 a cobranded web page. In the described embodiment, a cobranded web page includes a personalized logo and a startpage data indicated by the cobranding partner. Once built, the cobranded web page is sent 3408 to the requesting browser. Example of filters include but are not limited to: filtering based on the identity of the poster of an RFP or request for commodity; filtering based on the desired delivery date; filtering based on the desired quantity; filtering based on a category (such as “consulting,” “computer-related,” programmer,” or “java programmers”); filtering on a feedback score of the buyer or seller; filtering on a quality rating of the buyer or seller; filtering based on a combination of the above or a negation of the above. If no filtering is desired, all available marketplace data matching the request is sent to the requesting browser.

FIGS. 34(b)-34(d) show an alternate embodiment in which server 130 does not build an entire web page, but instead returns pieces of a cobranded web page in response to requests. In element 3412 of FIG. 34(b), the central server 130 receives a request (such as an http request) for marketplace content via a web page of a cobranding partner. FIG. 34(c) shows an example where the browser has requested generic content, i.e., content that is the same for all requesting browsers. This may include data about the marketplace service itself, generic ad content, etc. Again, some embodiments incorporate such information in a complete web page that is built on the central server 130 and then sent as shown in FIG. 34(d).

FIG. 34(d) shows an example where the browser has requested cobranding partner-specific content that is not marketplace data. This may include special banners, special ads. special designs or logos. Again, some embodiments incorporate such information in a complete web page that is built on the central server 130 and then sent as shown in FIG. 34(a).

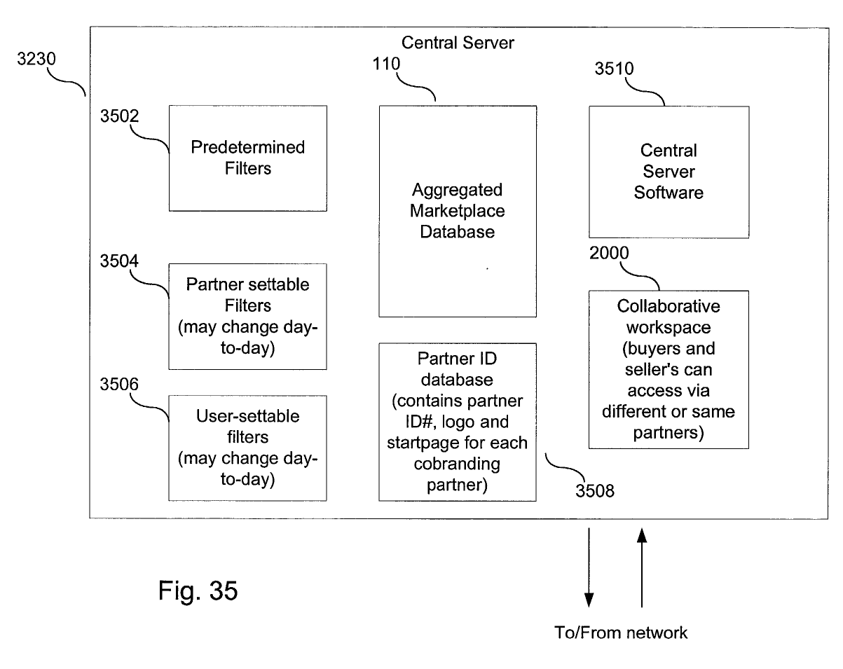

FIG. 35 is a diagram of an embodiment of the central web server 130. Central web server 130 includes a set of filters, including predetermined filters 3502, filters settable by partners on a request-by-request basis 3504, and filters settable by users on a request-by-request basis 3506. Server 130 also includes an aggregated marketplace database 110 that contains all marketplace data and one or more partner-specific databases 3508. Partner-specific database 3508 includes data such as the user ID#s of cobranding partners, the logo and startpage information for each partner, and the appearance information for the cobranded pages of each partner. This information is used by server 130 to build cobranded web pages having the appearance specified by the partners. Lastly, server 130 includes server software 3510 that implements the functionality described herein. Server software includes the basic server functionality as well as specialized scripts and software to implement marketplace-related server functionality. Lastly, server 130 preferably includes a collaborative workspace area 2000.

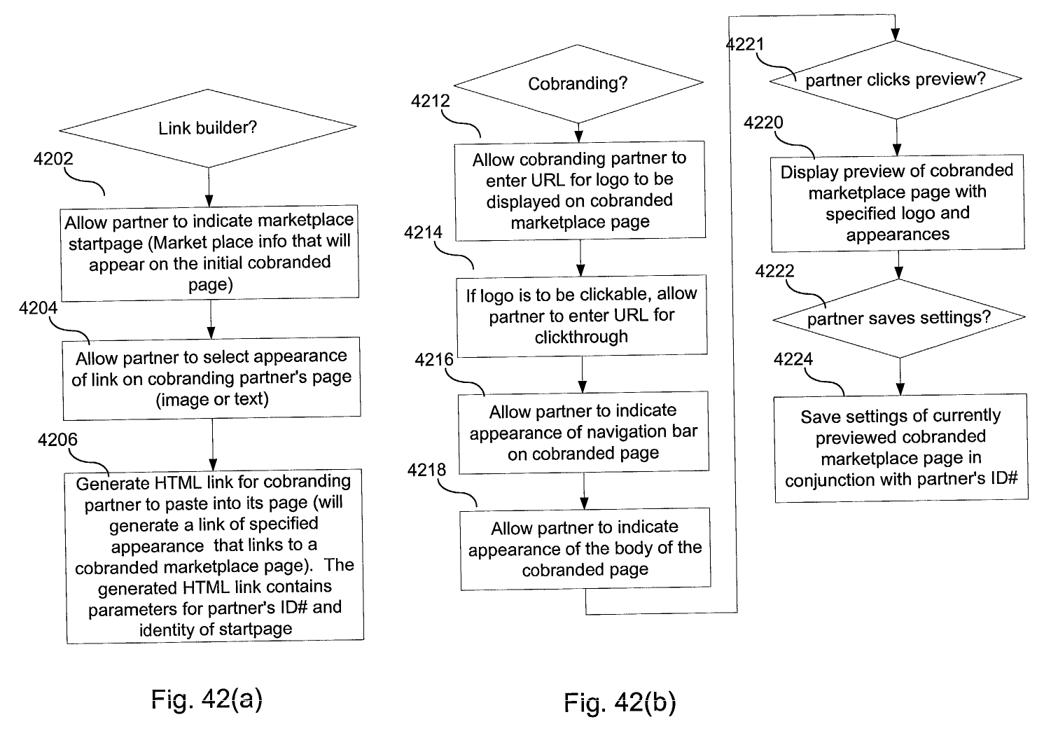

The following paragraphs describe online tools available from central server 130 that allow a cobranding partner to build a link on his page to a cobranded site and that further allow the partner to specify the appearance and functionality of his cobranded site. A cobranding partner will set up his cobranded web page and then create a link to the page, which he places on his own web site. Users clicking on this link will be sent to the cobranded page. These examples will be discussed in connection with the flow charts of FIGS. 42(a) and 42(b), which show a method of allowing a partner to set up a cobranded web page.

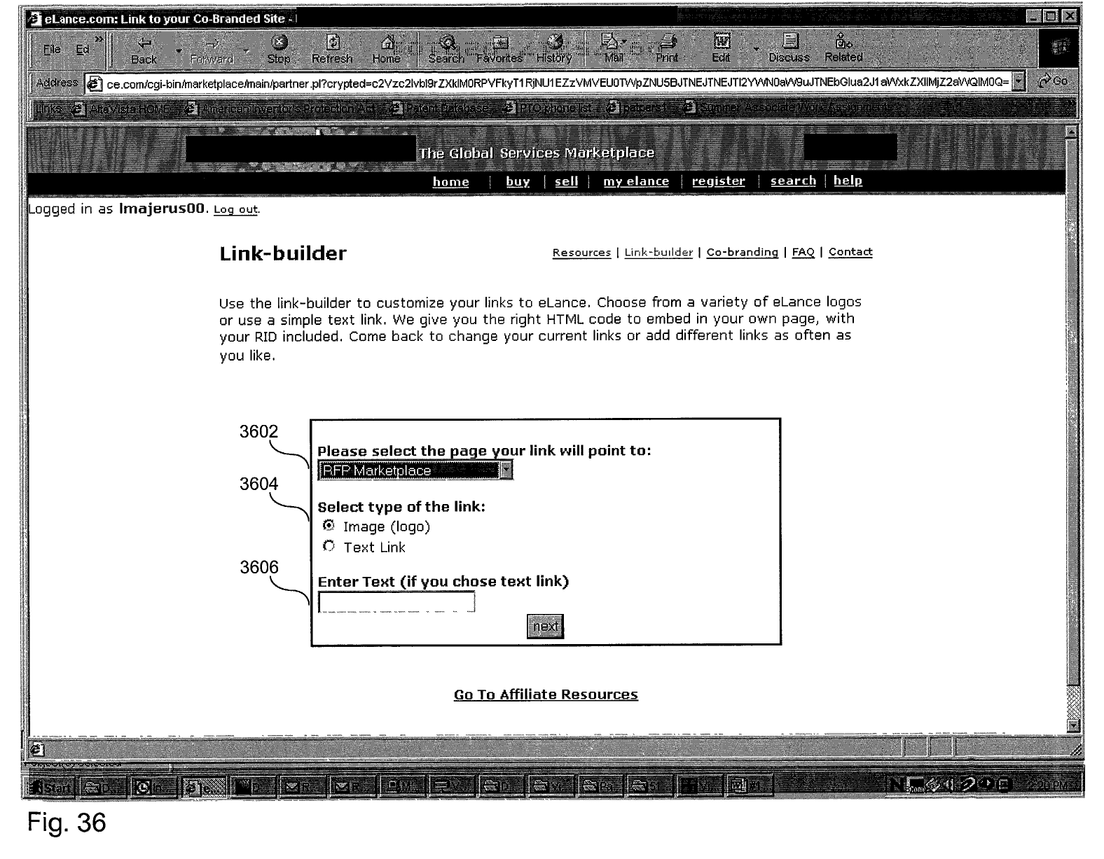

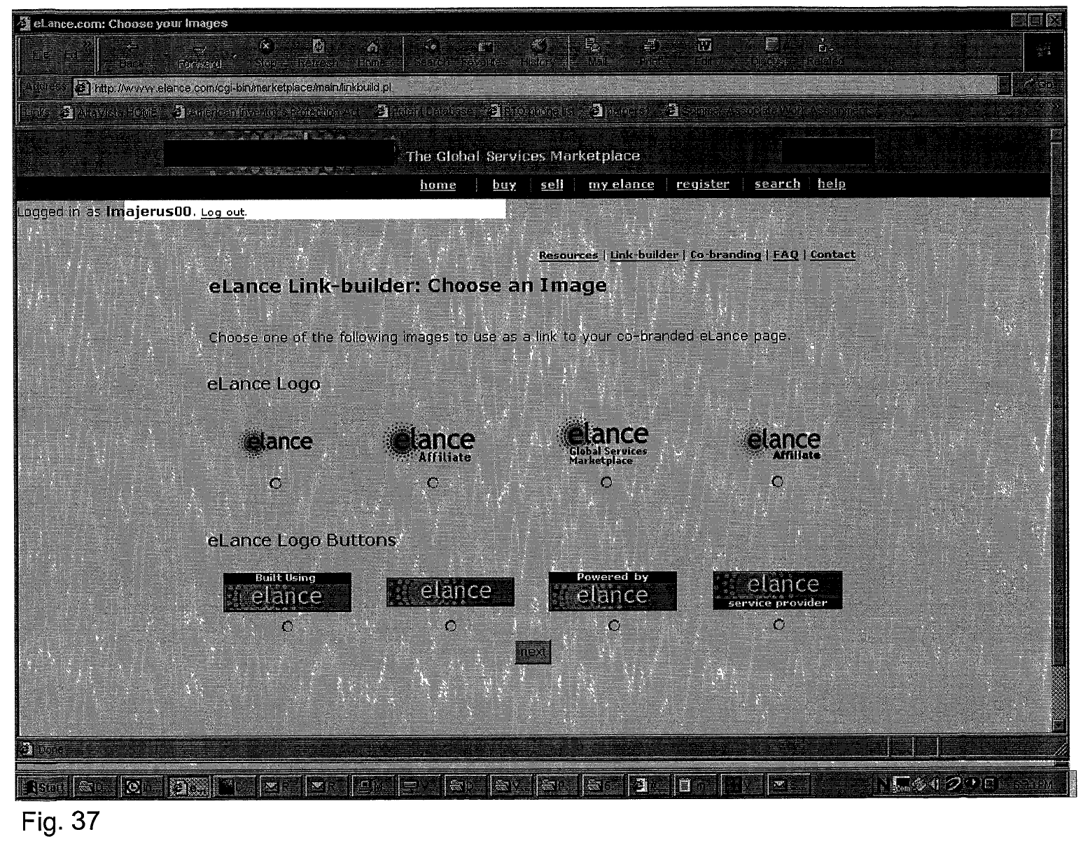

FIGS. 36 and 37 are examples of a web page that allows a partner to build a link that will be placed on the partner's web page and that will point to the cobranded page. In element 4202 of FIG. 42(a), the partner specifies which start information he wants to be displayed when the cobranded web page is first displayed. In the described embodiment, the choices are shown using a drop down menu 3602. In the figure, the partner has chosen to user the RFP Marketplace as his startpage. Other options in the described embodiment include: the marketplace home page, a cobranding introduction page, post an RFP, seller's page, buyer's page, start in a box, search page, an affiliate home page, and an “about” page for the owner of central server 130. It will be understood that any other appropriate startpage can be offered to the partner as a startpage.

In element 4204 of FIG. 42(a), the partner indicates or selects the appearance of a link that will be placed on the cobranding partner's web page. In the described embodiment, the partner can choose between an image link and a text link. If the partner chooses a test link, he is allowed to enter the text for the link into box 3606. If the partner chooses an image link, he is prompted to pick a predefined image link using the page of FIG. 37 (or he is allowed to enter a URL of his own image, not shown). The image links of FIG. 37 are provided as examples only. Any appropriate image links could be used.

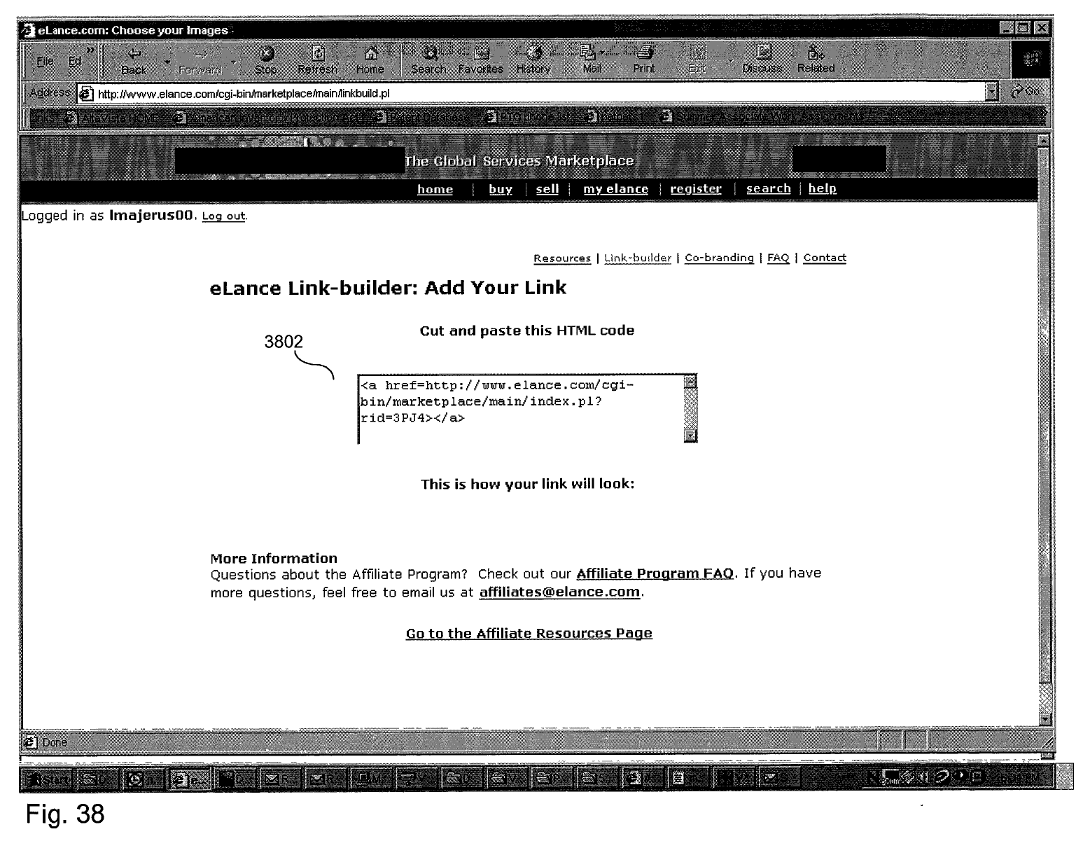

In element 4206 of FIG. 42(a), central server 130 (or another appropriate server) receives the data input by the partner and generates an HTML link for the cobranding partner to paste into its own web page. FIG. 38 is an example of web page that provides a link for a partner to place on his web page to allow users to access the cobranded page. Central server 130 generates 4206 the page shown in FIG. 38 in response to a request sent when the partner hits the “next button” in the link-building page. The partner can cut and paste this link into his own page.

In the example, the generated link is:

<a href=http://www.elance.com/cgi-bin/marketplace/main/index.pl?rid=3PJ4></a>

This link points to the startpage information chosen by the partner (here, the main page).

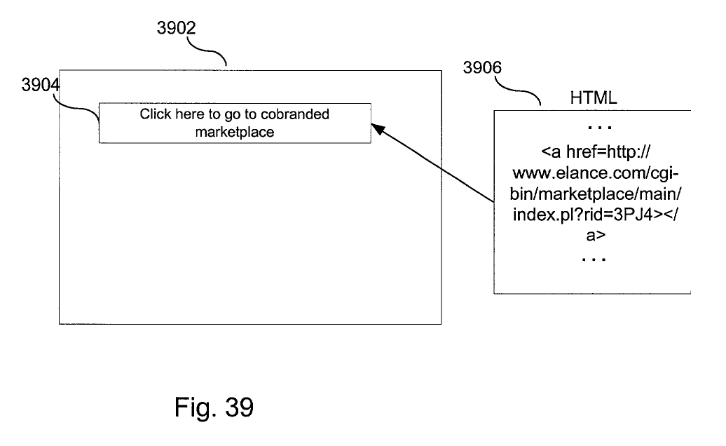

FIG. 39 is example of a partner web page having a link to a cobranded page of the partner. This link was created using the online tool in FIGS. 36-38. When a user clicks on text link 804 in the example, the browser will request a cobranded page at:

www.elance.com/cgi-bin/marketplace/main/index.pl

The user ID# of the cobranding partner is passed as a RID parameter in the request. Thus, when server 130 responds to the request, it will return a cobranded page containing the correct startpage (here the startpage “main” is specified in the URL) and it will give the cobranded page the appearance associated with the cobranding partner having the user ID specified. This appearance was previously stored on the server 130 in connection with the partner ID#.

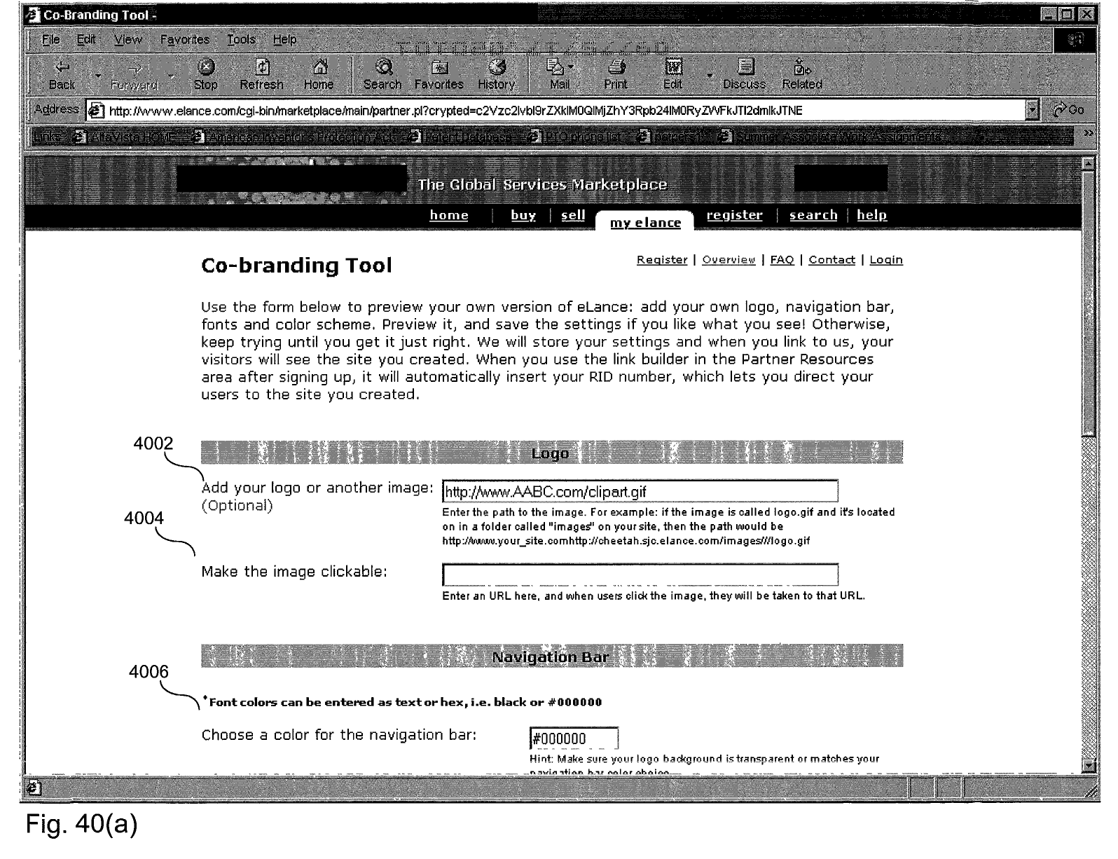

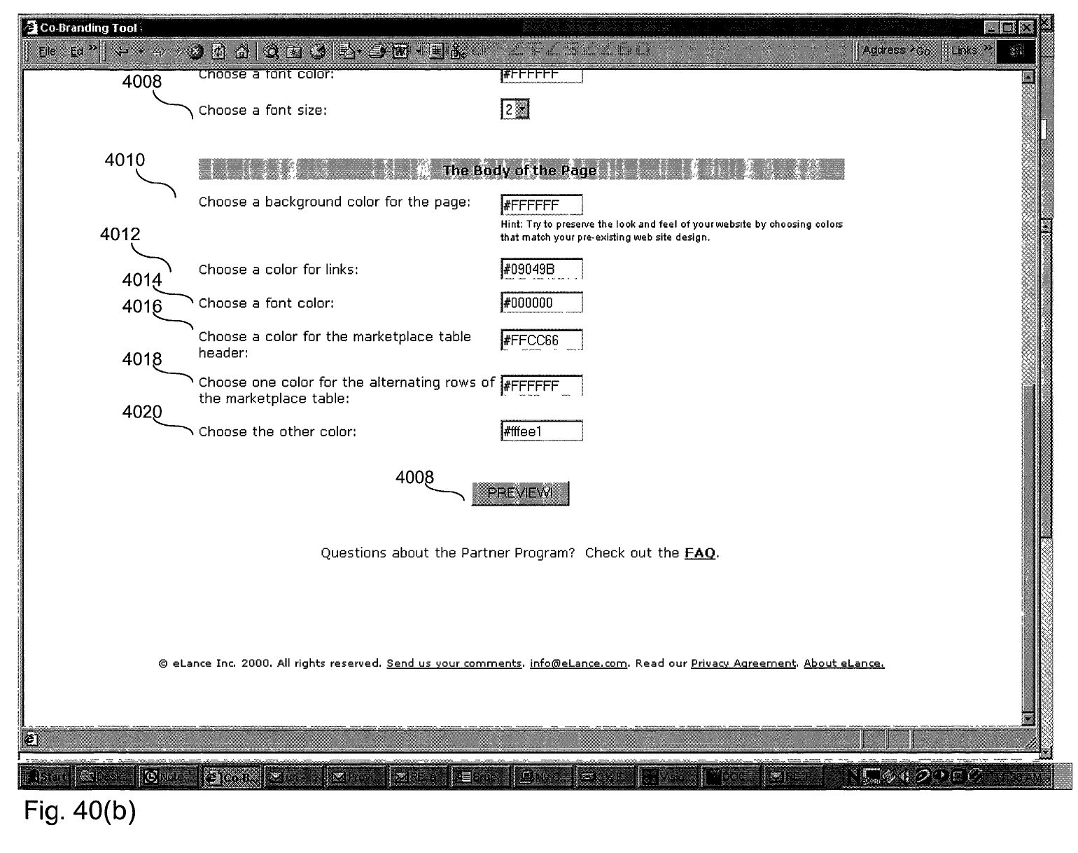

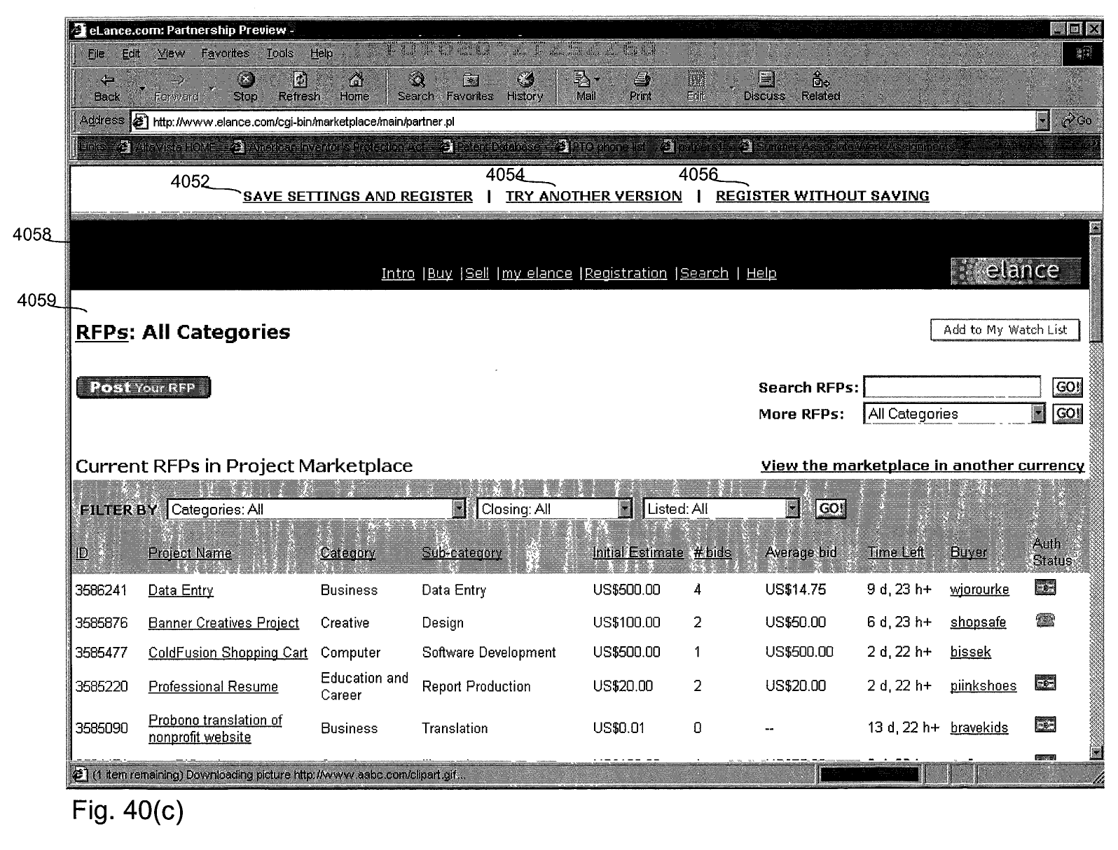

In FIGS. 40(a) and 40(b), the partner is allowed to specify the appearance of his cobranded web page. In element 4212 of FIG. 42(b), central server 130 (or another appropriate server) allows the partner to enter a URL (or other appropriate indicator) for a logo to be displayed on the cobranded web page/site. In FIG. 40(a), the partner enters the URL of his logo:

http://www.ABC.com/clipart.gif

This logo for the ABC Corp. is shown in the examples of FIGS. 41.

If the partner desires that his logo on the cobranded page be clickable, in element 4214 of FIG. 42(b), the partner enters a URL (or other appropriate indicator) for a logo to be displayed on the cobranded web page/site. In FIG. 40(a), the partner does not want his logo to be clickable, and so does not enter a URL.

In element 4216 of FIG. 42(b), central server 130 allows the partner to indicate an appearance of a navigation bar on the cobranded web page/site. In FIG. 40(a), the partner chooses a color for the navigation bar. As shown in FIG. 40(b), the partner also chooses a font size and font color. Other appropriate appearance choices can be presented to the user in other embodiments.

In element 4218 of FIG. 42(b), the partner indicates an appearance of a navigation bar on the cobranded web page/site. In FIG. 40(b), the partner chooses a background color 4010 for the cobranded page, a link color 4012, a font color 4014, a color for a marketplace table header 4016, and two colors 4018, 4020 for the alternating rows of the marketplace table (a table containing marketplace data). Other appropriate appearance choices can be presented to the user in other embodiments.

In element 4221 of FIG. 42(b), central server 130 detects that the partner has clicked on preview button 4008 (FIG. 40(b)). The server 130 then sends 4220 a preview view of the cobranded page to the partner's browser. The previewed page has the appearance specified by the partner. In the described embodiment, if the partner has not specified a startpage, a default startpage is used for the preview.

FIG. 40(c) shows an example of a preview of a cobranded web page. The example includes a navigator bar 4058 including a logo (here, for ABC Corp.) and marketplace data in the startpage 4059. The preview page also includes links that are not a part of the final cobranded page. These include a link 4052 to allow the partner to save the current settings to be used in his cobranded page; a link 4054 to allow the partner to quit without saving his settings; and a link 4056 to return to an information page.

In element 4224 of FIG. 42(b), central server 130 detects that the partner has clicked on the save setting links 4052 (FIG. 40(b)). The server 130 then saves the current settings for the partner's cobranded page in database 3508 in conjunction with the partner's ID# (FIG. 35). These settings will be used in the future when the server builds a cobranded page accessed via this partner. Note that the startpage is not saved in this embodiment, although it might be saved in other embodiments.

FIGS. 41(a) and 41(b) are examples of cobranded web pages having the same logo but different startpages. The cobranded page of FIG. 41(a) has a “global services marketplace” startpage. The cobranded page of FIG. 41(b) has an “RFP” startpage. The navigator bar, logos, and color appearance values are the same in this example. The HTML for the color appearance of the pages is also the same in the example (although it is not shown). Note that, in the example of FIG. 41(b), a slider bar allows users viewing the cobranded page to scroll on the page.

FIG. 41(c) is an example of a web page where the startpage is displayed in a frame, so the logo is always visible. In this example, the partner has placed the link created by the link-builder online tool within a frame. He has placed his navigator bar as a part of his own page, outside the frame.

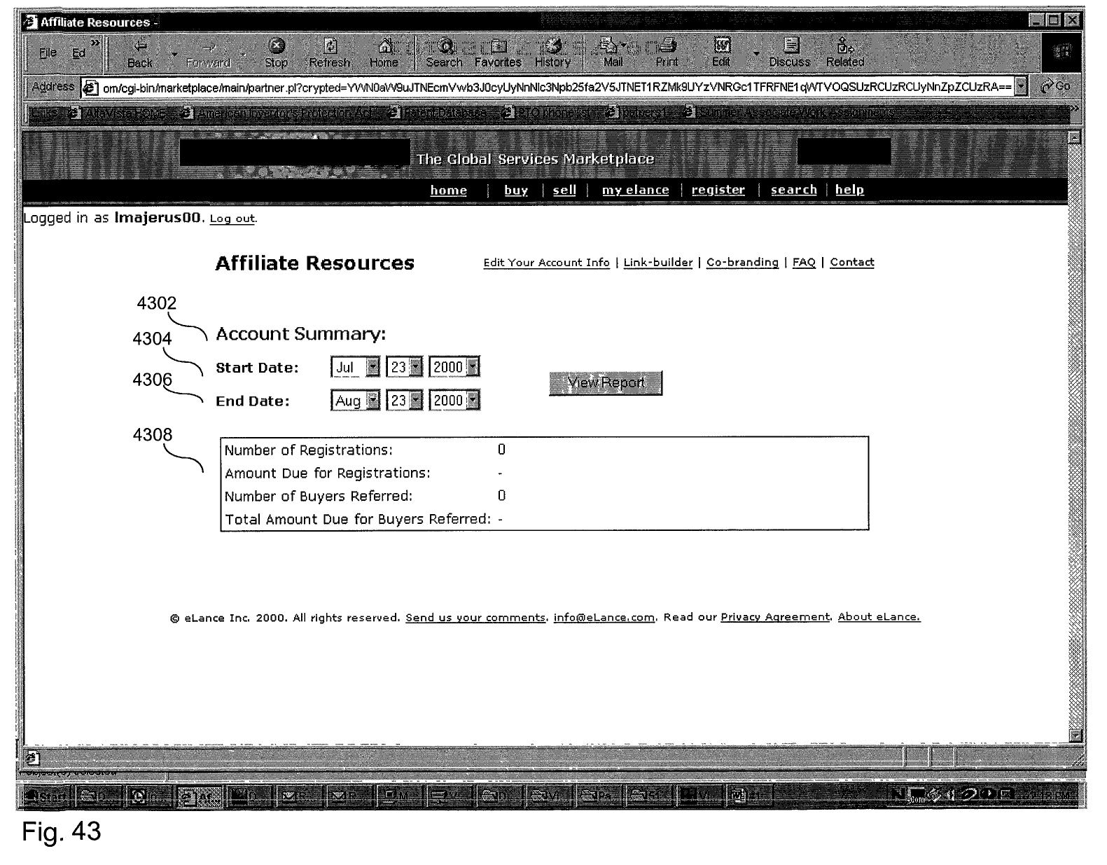

FIG. 43 is an example of an affiliate page. Partners can check access statistics about their cobranded pages using this web page from server 130. For a specified range 4204, 4206, the partner can view a number of registered users, amount due for registered users; number of buyers referred, and total amount due for buyers referred. In the described embodiment, partners are paid a predetermined amount for each user that registers via his cobranded page and a predetermined amount for each buyer that is referred via his cobranded page. In the described embodiment, partner statistics are stored in database 3508 or a similar database.

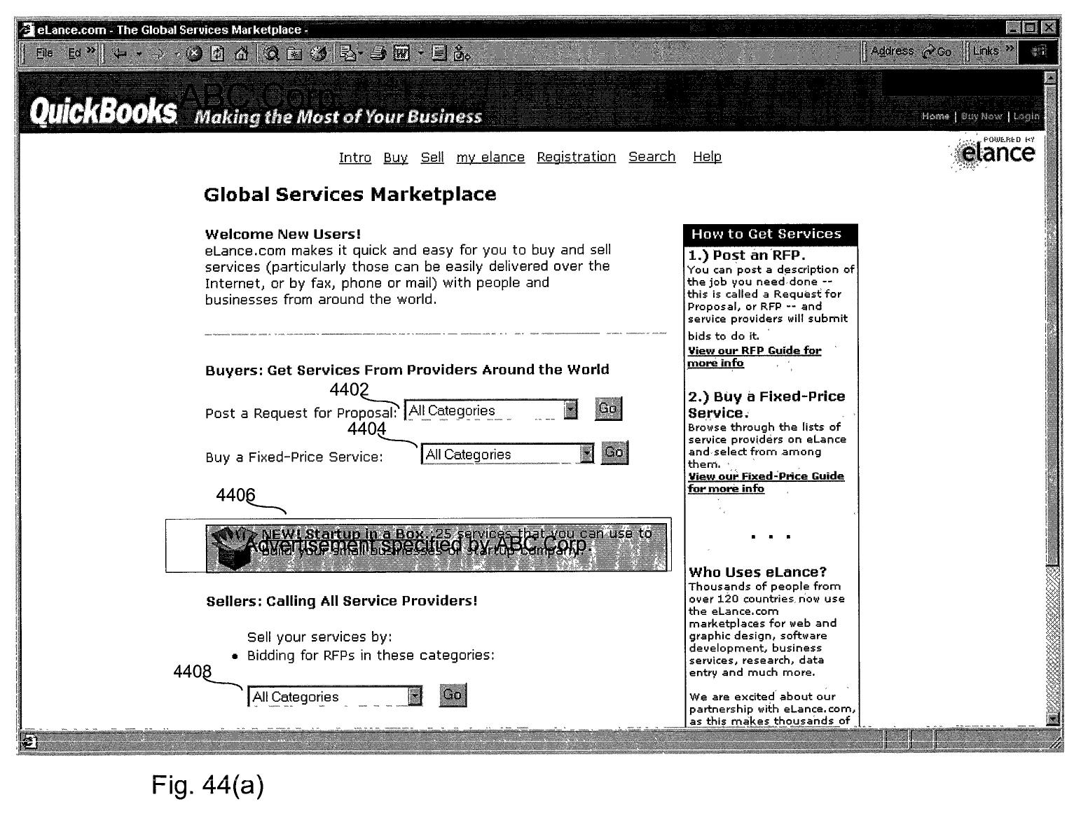

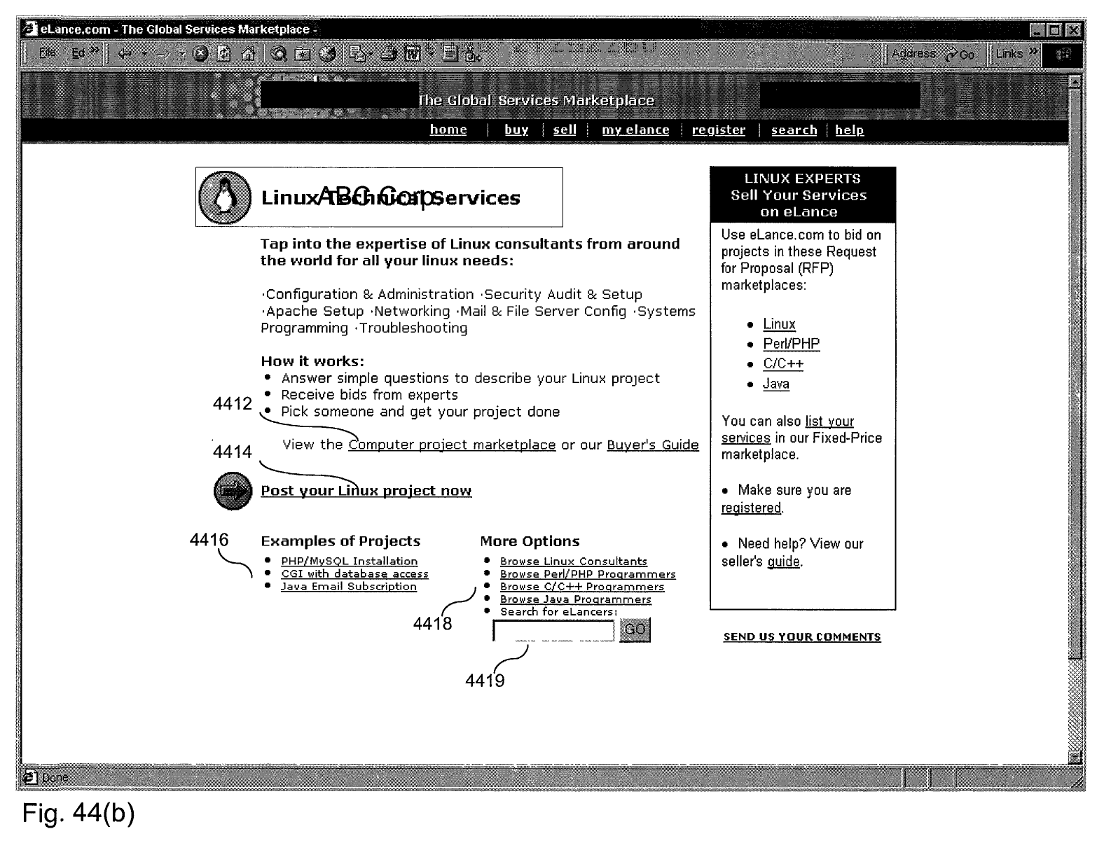

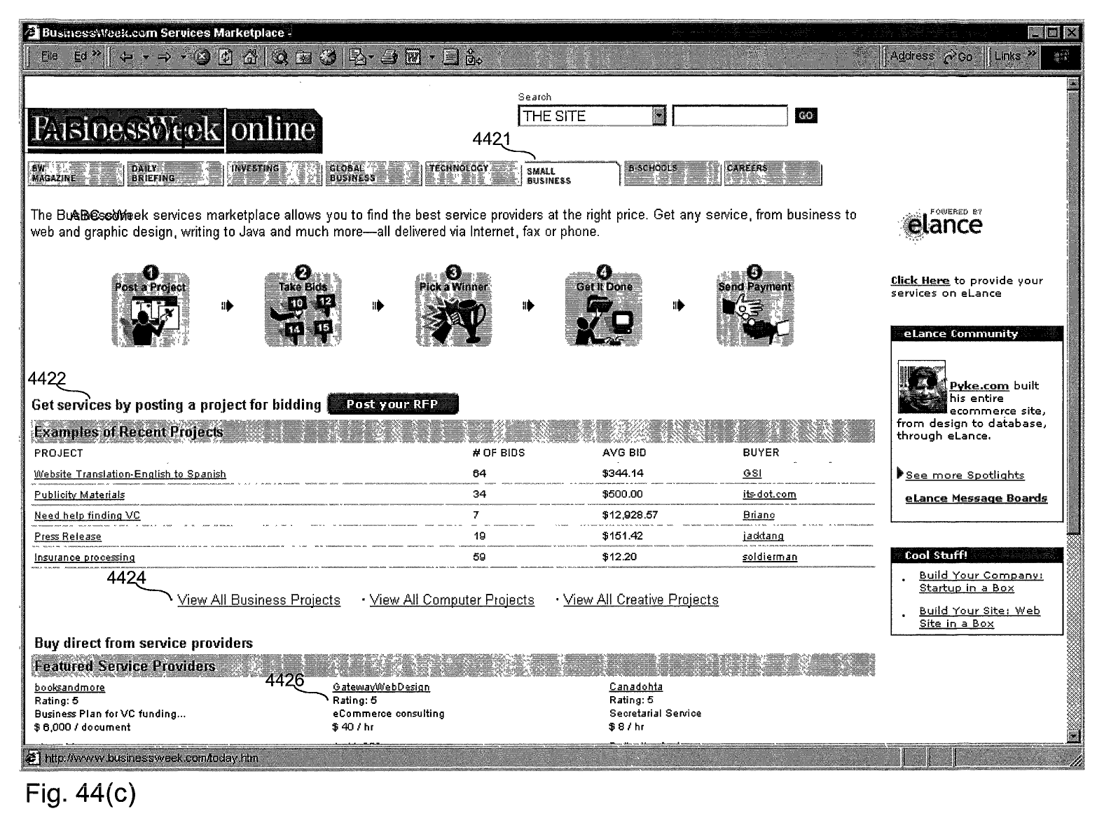

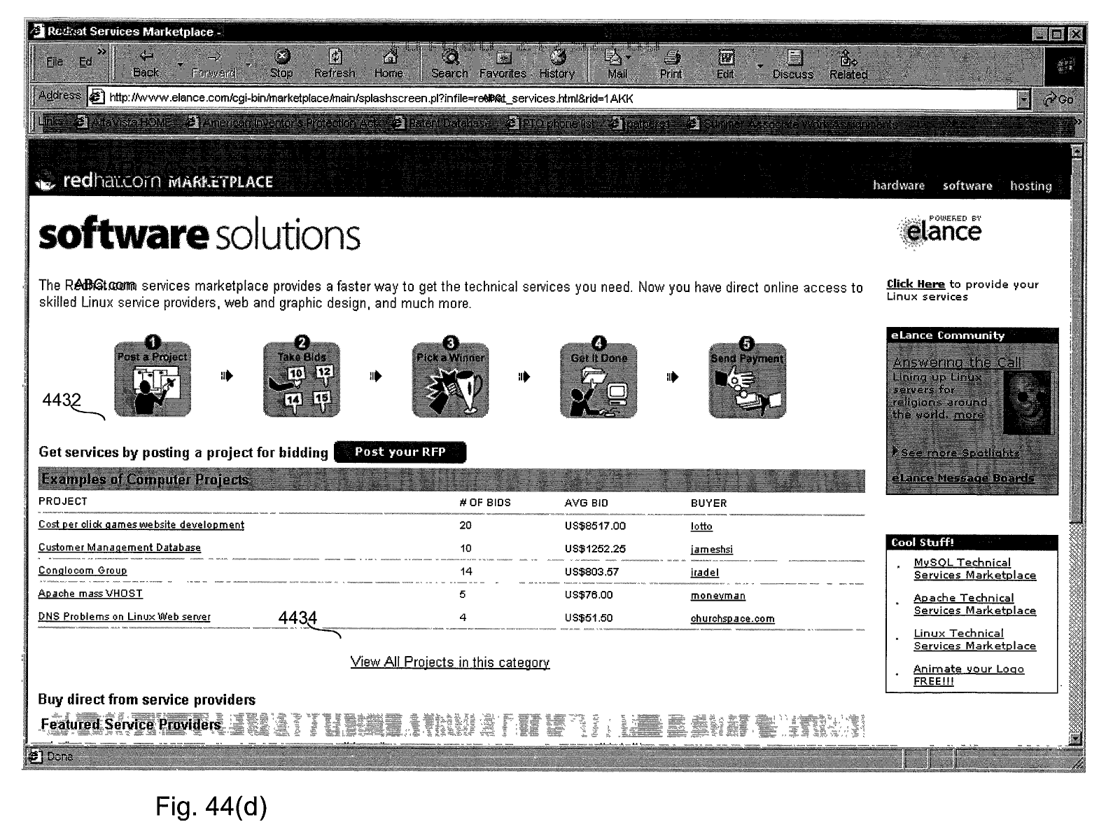

FIGS. 44(a) through 44(d) show examples of cobranded web pages.

FIG. 44(a) shows an example of a cobranded web page where the owner of server 130 and the cobranding partner have reached an understanding as to placement of marketplace data on the page. Thus, when server 130 determines that a user has entered the page via a partner's site (by way of the user ID#) server 130 returns a cobranded web page having a layout and functionality predetermined by the partner and stored on server 130. This allows more variation in the web page layout and functionality than is available using the online tool discussed above, In the example, the user is allowed to post an RFP in any category specified by a drop down menu 4402. In the example, the user is allowed to buy a fixed price service in any category specified by a drop down menu 4404. In the example, the user is allowed to bid for an RFP in any category specified by a drop down menu 4408. Ad 4406 is either specified by the partner or selected based on the identity of the partner.

In certain embodiments, partners can also specify the user interface mechanism, such as whether a choice is presented to a user by a drop down menu or a radio bar. During a setup of the cobranded page, the partner decides which interface mechanism is preferable for the cobranded site. The chosen UI mechanism is stored on server 130 in connection with the user ID# of the partner.

FIG. 44(b) shows an example of a cobranded web page that allows a user to view filtered marketplace data by clicking on links or by entering the filter terms. The user can filter so as to view only computer-related projects 4412. The user can post a project and have it automatically categorized as a Linux project by clicking link 4414. The user can click one of links 4416 to filter based on project types. The user can click on one of links 4418 to filter on job skill categories (such as types of computer programmers). Lastly, the user can enter a filter term 4419, which is passed to the server 130 so the server 130 can filter the marketplace data accordingly.

FIG. 44(c) shows an example of a cobranded web page that allows a user to view filtered marketplace data by clicking on links 4424 to view, respectively, business projects, computer projects, or creative projects. A group of links 4322 points to recent projects/RFPs. In addition, the cobranded web page contains links to featured web providers. 1226. These can be providers that have paid a premium (to server 130 or to the partner) or providers that have achieved a high rating (e.g., 5). Tabs 4421 indicate areas, each of which have predetermined links 4424 with associated filters.

FIG. 44(d) shows an example of a cobranded web page that allows a user to view filtered marketplace data by clicking on link 4434 to view all projects in the computer category. The partner has previously determined that its users will be interested in viewing computer-related projects. A group of links 4432 points to recent projects/RFPs.

Thus, in summary, the present invention allows a private marketplace owner to procure services in a customized manner. The marketplace owner may, for example, limit access to the marketplace, may establish a customized look and feel for the marketplace, and may manage and monitor the marketplace in numerous ways.

Accordingly, the present invention is intended to embrace all such alternatives, modifications and variations as fall within the spirit and scope of the appended claims and equivalents.

We claim:

1. A computer implemented method for procuring services, comprising:
establishing a private marketplace with access restricted to a predetermined set of buyers and a pre-identified set of vendors;
inviting bids on a project from a subset of the vendors;
receiving at least one bid on the project from at least one of the subset of vendors;
accepting one of the bids; and
working on the project with the vendor in a collaborative workspace.

2. The computer implemented method of claim 1, wherein the private marketplace is an online marketplace and establishing the private marketplace further comprises customizing the look and feel of the online marketplace.

3. The computer implemented method of claim 1, wherein the establishing of the private marketplace further comprises managing the pre-identified set of vendors.

4. The computer implemented method of claim 1, wherein the establishing of the private marketplace further comprises restricting the access of the users to one or more projects within the private marketplace.

5. The computer implemented method of claim 1, further comprising:
receiving invoices from the vendors for services provided by the vendors to the buyers, the invoices received at a centralized location;
consolidating at the centralized location the invoices received for the predetermined set of buyers;
sending a bill from the centralized location to an owner of the private marketplace;
receiving money at the centralized location from the owner of the private marketplace; and
distributing the money to the vendors.

6. The computer implemented method of claim 5, further comprising obtaining project approval before one or more stages in the procurement of services.

7. The computer implemented method of claim 1, further comprising monitoring the private marketplace.

8. The computer implemented method of claim 7, wherein monitoring the private marketplace further comprises receiving requested reports.

9. The computer implemented method of claim 7, wherein monitoring the private marketplace further comprises receiving planning reports.

10. The computer implemented method of claim 7, wherein monitoring the private marketplace further comprises receiving performance measurement reports.

11. A computer program product for procuring services, the computer program product comprising:
program code for establishing a private marketplace with access restricted to a predetermined set of buyers and a pre-identified set of vendors;
program code for inviting bids on a project from a subset of the vendors;
program code for receiving at least one bid on the project from at least one of the subset of vendors;
program code for accepting one of the bids; and
program code for working on the project with the vendor in a collaborative workspace.

12. The computer program product of claim 11, wherein the private marketplace is an online marketplace and the program code for establishing the private marketplace further comprises program code for customizing the look and feel of the online marketplace.

13. The computer program product of claim 11, wherein the program code for establishing of the private marketplace further comprises program code for managing the pre-identified set of vendors.

14. The computer program product of claim 11, wherein the program code for establishing of the private marketplace further comprises program code for restricting the access of the users to one or more projects within the private marketplace.

15. The computer program product of claim 11, further comprising:
program code for receiving invoices from the vendors for services provided by the vendors to the buyers, the invoices received at a centralized location;
program code for consolidating at the centralized location the invoices received for the predetermined set of buyers;
program code for sending a bill from the centralized location to an owner of the private marketplace;
program code for receiving money at the centralized location from the owner of the private marketplace; and
program code for distributing the money to the vendors.

16. The computer program product of claim 15, further comprising program code for obtaining project approval before one or more stages in the procurement of services.

17. The computer program product of claim 11, further comprising program code for monitoring the private marketplace.

18. The computer program product of claim 17, wherein the program code for monitoring the private marketplace further comprises program code for receiving requested reports.

19. The computer program product of claim 17, wherein the program code for monitoring the private marketplace further comprises program code for receiving planning reports.

20. The computer program product of claim 17, wherein the program code for monitoring the private marketplace further comprises program code for receiving performance measurement reports.

21. A system for procuring services using a private marketplace, the system comprising:
a private marketplace owner;
at least one buyer, the buyer given access to the private marketplace by the private marketplace owner;
at least one vendor, the vendor bidding on a project posted by a buyer, wherein the buyer accepts the bid of the vendor and works on the project with the vendor in a collaborative workspace.

22. The system of claim 21, wherein the private marketplace is an online marketplace and wherein the private marketplace owner customizes the look and feel of the online marketplace.

23. The system of claim 21, wherein establishing the private marketplace further comprises managing the pre-identified set of vendors.

24. The system of claim 21, wherein establishing the private marketplace further comprises restricting the access of the users to one or more projects within the private marketplace.

25. The system of claim 21, further comprising a central server wherein the central server receives invoices from the vendors for services provided by the vendors to the buyers, consolidates the invoices received for the buyers, sends a bill to the private marketplace owner, receives money from the private marketplace owner, and distributes the money to the vendors.

26. The system of claim 25, wherein the buyer obtains project approval before one or more stages in the procurement of services.

27. The system of claim 21, wherein the private marketplace owner monitors the private marketplace.

28. The system of claim 27, wherein the monitoring of the private marketplace further comprises receiving requested reports.

29. The system of claim 27, wherein the monitoring of the private marketplace further comprises receiving planning reports.

30. The system of claim 27, wherein the monitoring of the private marketplace further comprises receiving performance measurement reports.
